(19) United States
(12) Patent Application Publication
(10) Pub. No.: US 2006/0055838 A1
(43) Pub. Date: Mar. 16, 2006

(54) Light recycling film and display

(75) Inventors: Xiang-Dong Mi, Rochester, NY (US); Gary E. Nothhard, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/247,880

(22) Filed: Oct. 10, 2005

Related U.S. Application Data
(63) Continuation-in-part of application No. 10/939,656, filed on Sep. 13, 2004.

(51) Int. Cl. G02F 1/135

(52) U.S. Cl. 349/30

(57) ABSTRACT

A liquid crystal device display (20) has a backlight unit (56) for providing illumination, a rear polarizer (50b) disposed proximate the backlight unit (56) for receiving the incident illumination and transmitting substantially polarized illumination, a liquid crystal spatial light modulator for forming a display beam by selective, pixel-wise modulation of the polarization of the substantially polarized illumination, and a reflective polarizer (52a) disposed between the liquid crystal spatial light modulator and a front polarizer (50a).

### CROSS REFERENCE TO RELATED APPLICATIONS

The present application is a continuation-in-part of application Ser. No. 10/939,656, filed Sep. 13, 2004 entitled “Dark State Light Recycling Film and Display” by Xiang-Dong Mi.

### FIELD OF THE INVENTION

This invention generally relates to LCD displays using polarizers and more particularly relates to an LCD display using a reflective polarizer to recycle white, gray scale, or dark state light that otherwise is absorbed by the front polarizer of the LCD.

### BACKGROUND OF THE INVENTION

Conventional Liquid Crystal Device (LCD) displays form images by modulating the polarization state of illumination that is incident to the display surface. In a typical back-lit LCD display, an arrangement of polarizers is used to support the LCD modulation, including a rear polarizer, between the LCD and the light source, to provide polarized light to the LCD spatial light modulator and a front polarizer, acting as an analyzer. (By definition, the front polarizer is designated as the polarizer closest to the viewer.) In operation, each pixel on the display can have either a light state, in which modulated light that is aligned with the transmission axis of the front polarizer is emitted from the display, or a dark state, in which light is not aligned with the transmission axis of the front polarizer and is effectively blocked from emission.

Referring to FIG. 6, there is shown, in summary form, the behavior of key components of a display for handling incident polarized light to each pixel, showing the symbols and graphic conventions used in a portion of the subsequent description. Orthogonal P- and S-polarization states are indicated by lines or circles, respectively, superimposed on arrows that indicate incident light direction. Transmission axes are similarly indicated by a double-sided arrow or a circle. An absorptive polarizer 50a, 50b, transmits polarized light that is aligned with its polarization axis and absorbs polarized light that is orthogonally oriented. By comparison, a reflective polarizer 52a, 52b transmits polarized light that is aligned with its polarization axis and reflects polarized light that is orthogonally oriented. An individual LC component 54a/54b modulates the incident display beam by modulating the substantially polarized illumination beam in pixel-wise fashion. Following the convention used in this specification, an off state LC component 54a rotates the polarization of incident light. An on state LC component 54b does not rotate the polarization of incident light. The general nomenclature “LC component”, as used in this disclosure, applies to a light-modulating element on the LCD spatial light modulator itself. The LCD spatial light modulator can be considered as an array of LC components 54a/54b.

There are two possible states for any pixel modulated by the LCD spatial light modulator: a dark state and a light state. In this application, the terms “dark state” and “light state” are used to describe the pixel state; the terms “on state” and “off state”, as noted above, refer to the polarization activity of the LC component itself, rather than to the pixel state that is represented.

It is significant to observe that the characteristics of each type of LCD spatial light modulator determine whether or not the on state of each LC component provides a dark state or light state to its corresponding pixel. As stated above, the examples illustrated in the present application use the following convention:
(i) an on state LC component 54b provides a dark state pixel;
(ii) an off state LC component 54a provides a light state pixel. However, the opposite pairing of on and off states to light and dark state pixels is also possible. For subsequent description in this application, except where specifically noted otherwise, the convention stated here and illustrated in FIG. 6 applies.

FIG. 1A shows a conventional arrangement of LCD display 10 with a front polarizer 50a, rear polarizer 50b, a backlight unit 56, a reflective film 57, with off state LC component 54a that converts S-polarization (circle) to P-polarization (line) (and, conversely, converts P-polarization to S-polarization). Unpolarized light is emitted from backlight 56. In this light state, only light having S-polarization is transmitted through rear polarizer 50b, through off state LC component 54a, and through front polarizer 50a.

FIG. 1B shows the same components as FIG. 1A for a dark state. Here, on state LC component 54b does not change the incident light polarization (that is, S-polarization remains S-polarization, P-polarization remains P-polarization). Light having s-polarization is transmitted through rear polarizer 50b. On state LC component 54b transmits this S-polarization light, which is then absorbed by front polarizer 50a, as indicated by symbol “X”.

The conventional arrangement of FIGS. 1A and 1B is workable, but constrains the overall amount of light that is available for display 10. Rear polarizer 50b absorbs light having P-polarization, effectively wasting this light energy. Ambient light does not impact the performance of this arrangement. Referring to FIG. 1C, it is seen that half of the ambient light is absorbed by front polarizer 50a. The other half of the ambient light goes through off state LC component 54a, which rotates the polarization, then through rear polarizer 50b. Some portion of this light may be reflected back by reflective film 57 for reuse. Referring to FIG. 1D, the dark state handling of ambient light is shown. Here, front polarizer 50a transmits only the light having P-polarization. On state LC component 54b does not change light polarization. Rear polarizer 50b then absorbs the ambient light not having s-polarization. In the dark state, then, ambient light effects are substantially diminished, with half of the light attenuated by front polarizer 50a and most of the other half attenuated by rear polarizer 50b.

As an attempt to increase the efficiency of display illumination, reflective polarizer 52b can be added to the group of supporting polarizers, as shown in FIGS. 2A-2D. Here, unpolarized light from backlight unit 56 goes to reflective polarizer 52b, which transmits light having one polarization (the S-polarization in the example of FIGS. 2A-2B) and reflects light having the orthogonal polarization. The reflected light component can be recycled, having its polarization state modified by backlight 56, by reflective film 57, or by some other device, such as a ¼ wave-plate or depolarization film, for example. Light state and dark state handling are performed in the same manner as was described with reference to FIGS. 1A-1D. In FIG. 2A, off state LC component 54a rotates the polarization of incident light and front polarizer 50a transmits light aligned with its transmission axis (that is, P-polarization light). In FIG. 2B, light having S-polarization is transmitted through rear polarization 50b. On state LC component 54b transmits this S-polarization light, which is then absorbed by front polarizer 50a, as indicated by symbol “X”.

FIGS. 2C and 2D show the impact of reflective polarizer 52b on incident ambient light. Ambient light having P-polarization is transmitted through front polarizer 50a and through off state LC component 54a or, conversely, through on state LC component 54b. Both rear polarizer 50b and reflective polarizer 52b transmit S-polarization light. Rear polarizer 50b absorbs P-polarization ambient light, which would be reflected from reflective polarizer 52b. In the dark state, ambient light effects are substantially diminished, with half of the light attenuated by front polarizer 50a and most of the other half attenuated by rear polarizer 50b.

The conventional arrangement using a reflective polarizer, as summarized in FIGS. 2A-2D, is described in a number of patent disclosures, including:
U.S. Pat. No. 6,661,482 entitled “Polarizing Element, Optical Element, and Liquid Crystal Display” to Hara;
U.S. Pat. No. 5,828,488 entitled “Reflective Polarizer Display” to Ouderkirk et al.;
U.S. Patent Application Publication 2003/0164914 entitled “Brightness Enhancing Reflective Polarizer” by Weber et al.; and,
U.S. Patent Application Publication 2004/0061812 entitled “Liquid Crystal Display Device and Electronic Apparatus” by Maeda.

In addition, T Sergan et al. (p. 514, (P-81) in “Twisted Nematic Reflective Display with Internal Wire Grid Polarizer” SID 2002) describe a wire grid polarizer used inside a reflective liquid crystal cell, simultaneously providing the functions of polarizer, alignment layer and back electrode.

It is known to use different types of polarizers with an LC display in order to achieve specific effects, depending on how the display is used. For example, U.S. Pat. No. 6,642,977 entitled “Liquid Crystal Displays with Repositionable Front Polarizers” to Kotchick et al. discloses a liquid crystal display module for a portable device, wherein the front polarizer may be any of a number of types and can be tilted or positioned suitably for display visibility. Similarly, U.S. Patent Application Publication No. 2003/0016316 entitled “Interchangeable Polarizers for Electronic Devices Having a Liquid Crystal Display” by Sahouani et al. discloses a device arrangement in which different types of front polarizers may be removably interchanged in order to achieve a suitable display effect. Among possible arrangements noted in both the '977 Kotchick et al. and the '16316 Sahouani et al. disclosures is the use of a reflective polarizer as the front polarizer for an LC display. It is significant to note that both the '977 Kotchick et al. and the '16316 Sahouani et al. disclosures emphasize that this arrangement would not be desirable in most cases, except where special “metallic” appearance effects, not related to increased brightness and efficiency, are deliberately intended. As both the '977 Kotchick et al. and the '16316 Sahouani et al. disclosures show, established practice teaches the use of reflective polarizer 52b between the illumination source, backlight 56, and rear polarizer 50b, as is shown in the arrangements of FIGS. 2A-2D, for improved brightness and efficiency. Established practice clearly does not use reflective polarizer 52b on the viewing side of LC component 54a/54b, except, where a “metallic-looking” display appearance is desired, as a less desirable substitute for front polarizer 50a. The use of a reflective polarizer for the front polarizer causes a dramatic loss in contrast ratio, effectively eliminating any possible benefit in increased brightness.

The conventional use of reflective polarizers shown in FIGS. 2A-2D, placed between the illumination source and the rear polarizer as described in the patent literature cited above, provides a measure of increased efficiency and brightness for LC displays. However, in order to use LC displays in a broader range of applications, there is a recognized need for improvement in display brightness, without adding cost or complexity to existing designs.

### SUMMARY OF THE INVENTION

This invention provides a liquid crystal display comprising:
(a) a backlight unit for providing illumination;
(b) a rear polarizer disposed proximate the backlight unit for receiving the incident illumination and transmitting substantially polarized illumination;
(c) a liquid crystal spatial light modulator for forming a display beam by selective, pixel-wise modulation of the polarization of the substantially polarized illumination; and,
(d) a reflective polarizer disposed between the liquid crystal spatial light modulator and a front polarizer. In various embodiments the reflective polarizer reflects a portion of dark state light, gray state light or white state light back toward the backlight unit.

It further provides a liquid crystal display comprising:
(a) a backlight unit providing illumination;
(b) a first reflective polarizer, having a transmission axis, for
   (i) transmitting that portion of light from the incident backlight unit illumination that has polarization parallel to the transmission axis; and,
   (ii) reflecting light having a polarization orthogonal to the transmission axis;
(c) a rear polarizer for receiving the polarized illumination transmitted from the first reflective polarizer;
(d) a liquid crystal spatial light modulator for forming an image by selective, pixel-wise modulation of polarization of the polarized illumination; and,
(e) a second reflective polarizer disposed between the liquid crystal spatial light modulator and a front polarizer for reflecting a portion of light from the liquid crystal spatial light modulator back toward the backlight unit.

It also provides a liquid crystal display comprising:
(a) a backlight unit for providing illumination;
(b) a rear polarizer having a transmission axis, the rear polarizer disposed proximate the backlight unit for receiving the incident illumination and transmitting substantially polarized illumination in alignment with its transmission axis;
(c) a liquid crystal spatial light modulator for forming a modulated beam by selective, pixel-wise modulation of the polarization of the substantially polarized illumination;
(d) a front polarizer having a transmission axis for transmitting the portion of the modulated beam having polarization in alignment with its transmission axis; and,
(e) a reflective polarizing element disposed between the liquid crystal spatial light modulator and the front polarizer, the reflective polarizing element reflecting a portion of light back toward the backlight unit; wherein the transmission axis of the front polarizer is oriented at an angle of between 5 degrees and 85 degrees with respect to the transmission axis of the rear polarizer.

It additionally provides a method for adjusting display brightness comprising:
a) providing backlight illumination to a transmissive liquid crystal display component;
b) forming an image beam by pixel-wise modulation of the polarization of the backlight illumination according to image data;
c) disposing a reflective polarizer in the path of the image beam;
d) determining, based on the image data, the relative proportion of dark pixels to light pixels; and,
e) modulating the backlight illumination brightness level based on the relative proportion of dark to light pixels for the displayed image.

It is a feature of the present invention that a reflective polarizer is deployed in the image display beam for reflecting dark state light for reuse. It is an advantage of the present invention that it provides incremental improvement in LC display brightness and efficiency over conventional designs.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1A is a schematic diagram showing, from a cross-sectional side view, an LC component of an LCD display in a light state having a front polarizer and a rear polarizer;

FIG. 1B is a schematic diagram showing, from a cross-sectional side view, an LC component of an LCD display in a dark state having a front polarizer and a rear polarizer;

FIG. 1C is a schematic diagram showing, from a cross-sectional side view, an LC component of an LCD display in a light state having a front polarizer and a rear polarizer and handling ambient light;

FIG. 1D is a schematic diagram showing, from a cross-sectional side view, an LC component of an LCD display in a dark state having a front polarizer and a rear polarizer and handling ambient light;

FIG. 2A is a schematic diagram showing, from a cross-sectional side view, an LC component of an LCD display in a light state having a front polarizer and a rear polarizer and a reflective polarizer in a conventional arrangement;

FIG. 2B is a schematic diagram showing, from a cross-sectional side view, an LC component of an LCD display in a dark state having a front polarizer and a rear polarizer and a reflective polarizer in a conventional arrangement;

FIG. 2C is a schematic diagram showing, from a cross-sectional side view, an LC component of an LCD display in a light state having a front polarizer and a rear polarizer and a reflective polarizer in a conventional arrangement, for handling ambient light;

FIG. 2D is a schematic diagram showing, from a cross-sectional side view, an LC component of an LCD display in a dark state having a front polarizer and a rear polarizer and a reflective polarizer in a conventional arrangement, for handling ambient light;

FIG. 3A is a schematic diagram showing, from a cross-sectional side view, an LC component of an LCD display in a light state having a front polarizer and a rear polarizer and a reflective polarizer between the front polarizer and the LC component according to the first embodiment of the present invention;

FIG. 3B is a schematic diagram showing, from a cross-sectional side view, an LC component of an LCD display in a dark state having a front polarizer and a rear polarizer and a reflective polarizer between the front polarizer and the LC component according to the first embodiment of the present invention;

FIG. 3C is a schematic diagram showing, from a cross-sectional side view, an LC component of an LCD display in a light state having a front polarizer and a rear polarizer and a reflective polarizer between the front polarizer and the LC component according to the first embodiment of the present invention, for handling ambient light;

FIG. 3D is a schematic diagram showing, from a cross-sectional side view, an LC component of an LCD display in a dark state having a front polarizer and a rear polarizer and a reflective polarizer between the front polarizer and the LC component according to the first embodiment of the present invention, for handling ambient light;

FIG. 3E is a schematic diagram showing, from a cross-sectional side view, an LC component of an LCD display in a light state having a front polarizer and a rear polarizer and a reflective polarizer between the front polarizer and the LC layer according to a comparative example;

FIG. 3F is a schematic diagram showing, from a cross-sectional side view, an LC component of an LCD display in a dark state having a front polarizer and a rear polarizer and a reflective polarizer between the front polarizer and the LC layer according to a comparative example;

FIG. 3G is a schematic diagram showing, from a cross-sectional side view, an LC component of an LCD display in a light state having a front polarizer and a rear polarizer and a reflective polarizer between the front polarizer and the LC layer according to another embodiment of the present invention;

FIG. 3H is a schematic diagram showing, from a cross-sectional side view, an LC component of an LCD display in a dark state having a front polarizer and a rear polarizer and a reflective polarizer between the front polarizer and the LC layer according to another embodiment of the present invention;

FIGS. 4A-4D are schematic diagrams showing, from a cross-sectional side view, another embodiment of the present invention, also using a second reflective polarizer between the rear polarizer and the backlight unit;

FIGS. 5A-5D are schematic diagrams showing, from a cross-sectional side view, a comparative example having a reflective polarizer without the front polarizer for backlight and ambient light;

FIG. 6 is a set of cross-sectional side views showing the nomenclature, symbols, and behavior for components of the present invention;

FIG. 7A is a top view showing a pattern of pixels for a typical image;

FIG. 7B is a schematic diagram showing, from a cross-sectional side view, two adjacent LC components, one in an off state, one in an on state;

FIGS. 8A-8C are graphs showing the relative efficiency gain based on the overall proportion of dark to light pixels;

FIG. 9 is a table showing calculated values of gain relative to transmittance, using the method of the present invention;

FIG. 10 shows a schematic block diagram of components used for brightness control in one embodiment;

FIG. 11 shows a flow chart of the logic used to adapt backlighting unit brightness based on overall image brightness;

FIG. 12 is a vector graph representation of conventional polarization states for LC devices;

FIG. 13 is a cross-sectional side view of polarizer and modulator components, showing modified notation used in a portion of the description of the present invention;

FIG. 14 is a schematic diagram showing, from a cross-sectional side view, two adjacent LC components, one in an off state, one in an on state, using the alternative polarization notation of FIG. 13;

FIG. 15A is a schematic diagram of a cross sectional view of an STN LCD;

FIG. 15B is a schematic diagram of an experimental setup measuring the polarization state of light passing through an LCD;

FIG. 16 is a diagram showing a set of transmission orientations measured in the configuration described with reference to FIG. 15B;

FIG. 17 is a diagram showing transmission orientations of the rear and front polarizers in a top view of a STN LC device;

FIGS. 18A-18D are schematic diagrams showing, from a cross-sectional side view, the polarization behavior of LC devices according to various embodiments; and,

FIGS. 19A-19C are schematic diagrams showing, from a cross-sectional side view, light recycling according to the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The apparatus and method of the present invention obtain improved efficiency and brightness from an LCD display by using one or more reflective polarizers to recycle dark state light.

One factor that complicates the problem of increasing display efficiency relates to the polarization behavior of the LC display itself. For many types of LC devices, the dark and light states of a pixel are provided by polarization states that are substantially orthogonal. Conventional types of LC devices that exhibit this behavior include twisted nematic (TN) liquid crystal displays, vertically-aligned (VA) liquid crystal displays, in-plane switching (IPS) LCDs, and optically compensated bend (OCB) displays or pi-cell LCDs. With these display types, using polarizers of various types in the optical path is relatively straightforward, since light and dark states have this orthogonal relationship. However, there are other types of LC devices for which this orthogonal relationship does not hold. For example, the Super Twisted Nematic or STN LC device is one type of device for which an acute angular relationship between light and dark states has been identified. For the sake of description, the first part of this disclosure is directed toward the simpler, more conventional case, in which LC devices have substantially orthogonal dark/light states. The more general case, comprehending light recycling for devices having some other non-orthogonal angular relationship of dark vs. light states, is then described later in this disclosure.

### First Embodiment

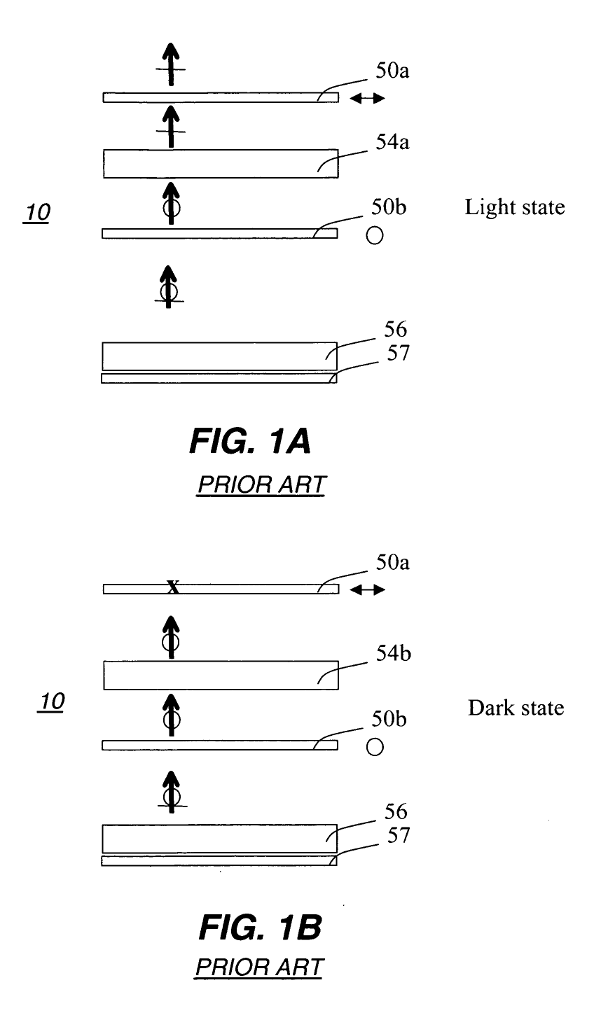

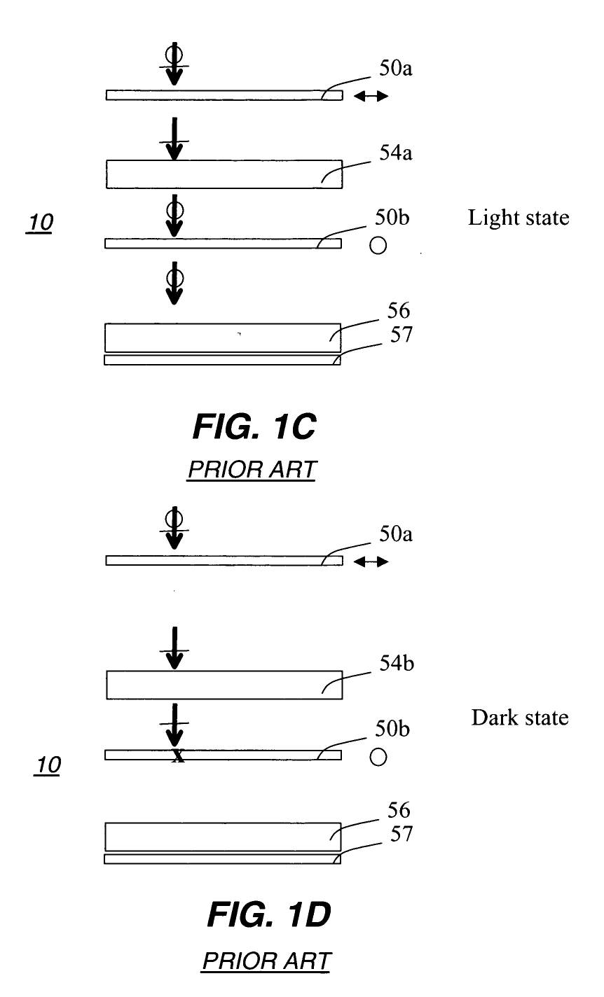

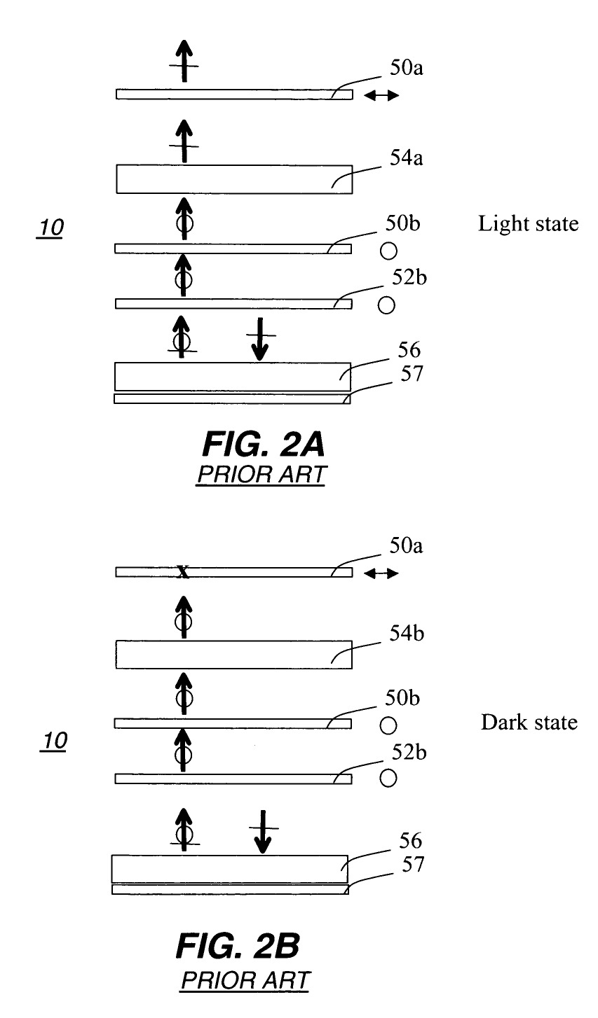

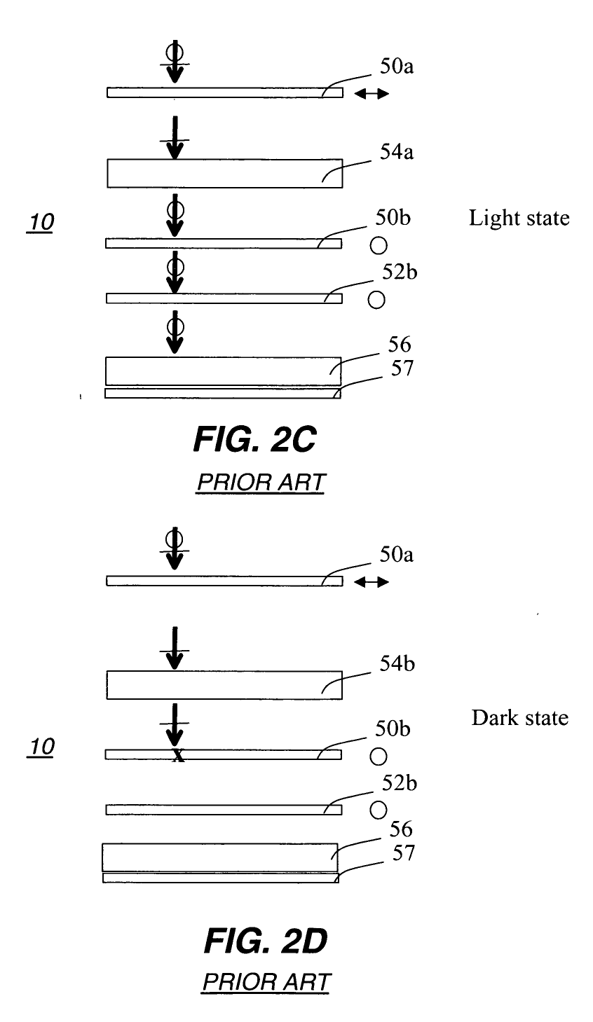

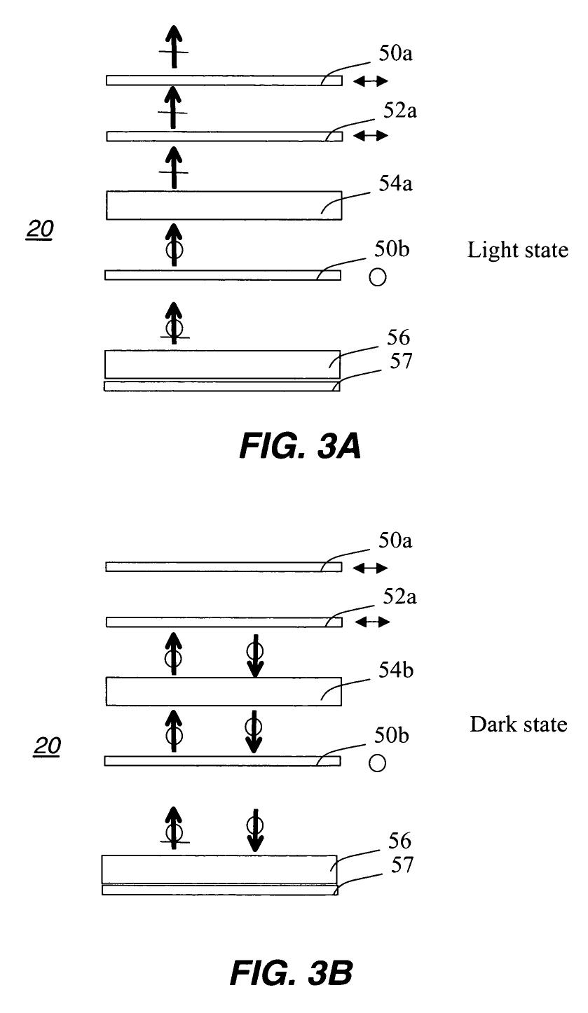

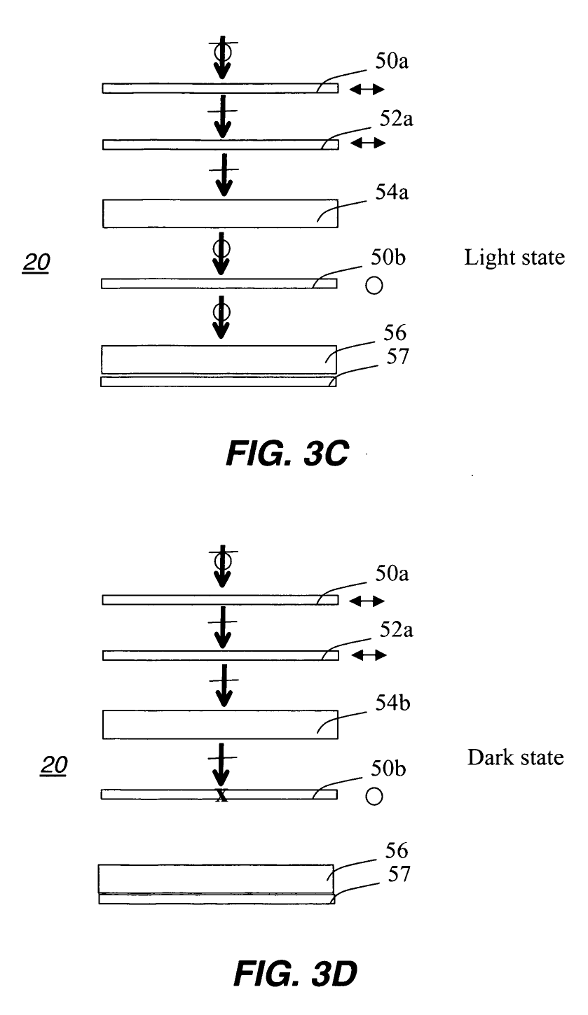

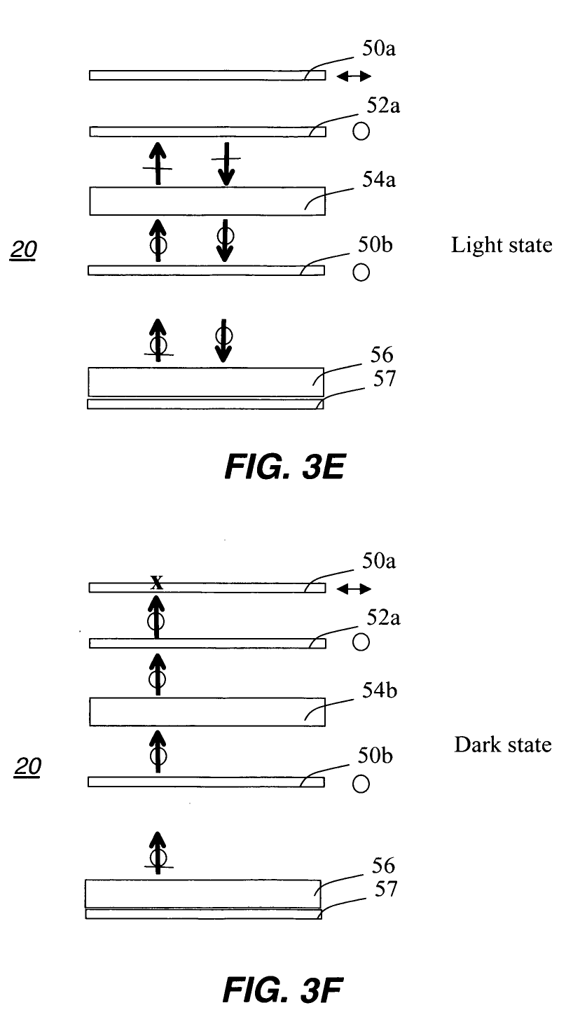

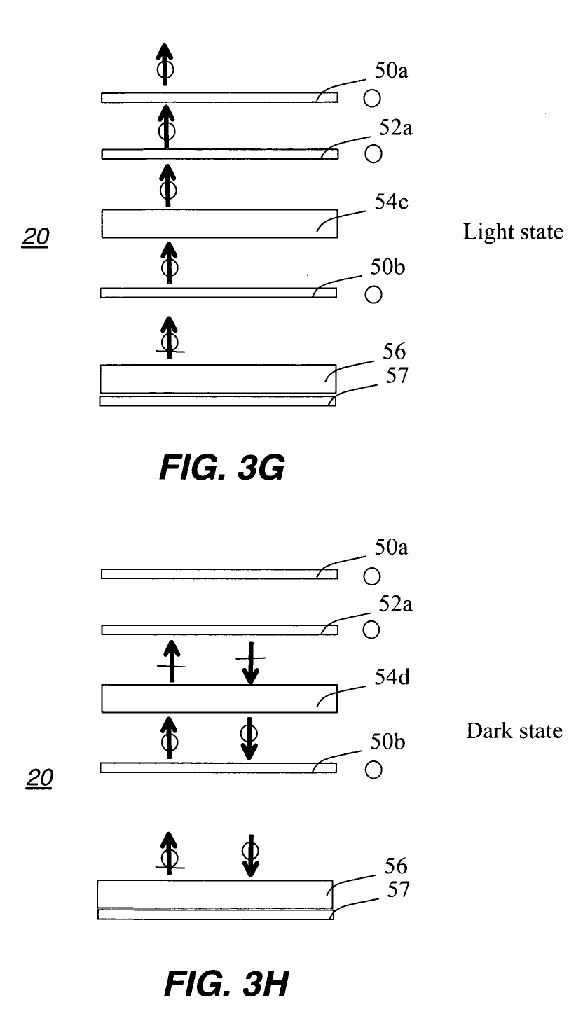

Referring to FIGS. 3A and 3B, there is shown, for light and dark states respectively, an embodiment of the present invention for an LCD display 20, in which reflective polarizer 52a is disposed between LC component 54a/54b and front polarizer 50a. Here, the transmission axes of rear and front polarizers 50b and 50a are perpendicular to each other, within ±10 degrees. Following the convention described with reference to FIGS. 1A-1D and 2A-2D, the LC off state converts P-polarization to S-polarization, and S- to P-polarization. The transmission axis of reflective polarizer 52a is parallel to the transmission axis of front polarizer 50a. Recycled light from reflective polarizer 52a has an orthogonal polarization with respect to front polarizer 50a.

FIG. 3A shows how LC display 20 handles light in the light state. Unpolarized light from backlight unit 56 is incident to rear polarizer 50b that transmits light having S-polarization, absorbing the P-polarization component. Off state LC component 54a rotates the light polarization to provide output light having P-polarization. This light is then transmitted through both reflective polarizer 52a and front polarizer 50a. Thus, in the light state, reflective polarizer 52a simply transmits the intended light.

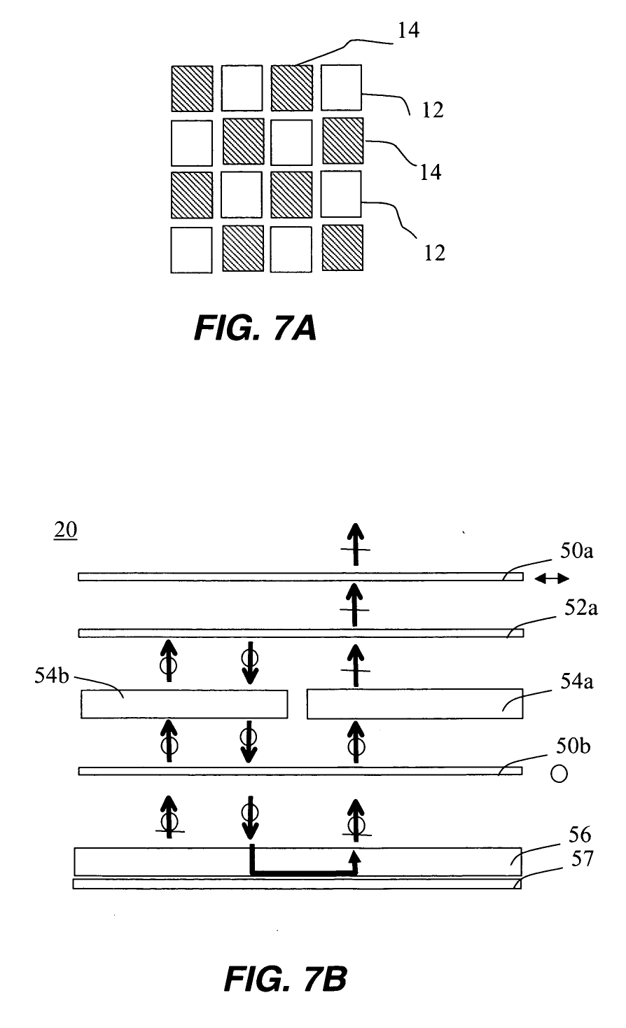

FIG. 3B shows how LC display 20 handles light in the dark state. On state LC component 54b performs no rotation of light polarization. Recalling FIGS. 1B and 2B, light having S-polarization must be absorbed by front polarizer 50a in the dark state. With the novel arrangement of FIGS. 3A-3B, however, reflective polarizer 52a reflects any light having S-polarization back toward backlight unit 56. This behavior has a recycling effect, allowing this dark state light to be reused for light state pixels. FIG. 7B shows the combined behavior of LCD display 20 for adjacent off state LC component 54a and on state LC component 54b.

FIGS. 3C and 3D show the behavior of LC display 20 for ambient light. As was described with reference to FIGS. 1C-1D and 2C-2D, front polarizer 50a absorbs light having S-polarization and transmits light having P-polarization. Reflective polarizer 52a transmits this light in the same way as does front polarizer 50a, so that there is essentially no change to ambient light handling from that shown in FIGS. 1C-1D and 2C-2D. Thus, it can be seen that by positioning reflective polarizer 52a between LC component 54a/54b and front polarizer 50a, some portion of dark state light is recycled and there is no added contrast degradation due to ambient light.

In the configuration of FIGS. 3A-3D, the transmission axis of reflective polarizer 52a is parallel to the transmission axis of front polarizer 50a. FIGS. 3E and 3F show an alternate case, in which the transmission axis of reflective polarizer 52a is orthogonal to the transmission axis of front polarizer 50a. Following the light path and polarization states indicated, it can be seen that this arrangement is not suitable. In the light state, light having P-polarization is reflected from reflective polarizer 52a, rather than being emitted. In the dark state, light having S-polarization is absorbed by front polarizer 50a instead of being reflected back for re-use. Thus, it can be seen that the transmission axis of reflective polarizer 52a matches the transmission axis of front polarizer 50a, within ±10 degrees, preferably within ±5 degrees.

### Second Embodiment

In the inventive embodiment of FIGS. 3G and 3H, the transmission axes of front and rear polarizers 50a and 50b are parallel to each other, within ±10 degrees. This arrangement may be suitable where on state and off state behavior of LC component 54c/54d is reversed from that of the preceding examples of FIGS. 1A-3F. Here, off state LC component 54c does not change the polarization of incident light; on state LC component 54d rotates the polarization of incident light. With this optional arrangement, the transmission axis of reflective polarizer 52a must match the transmission axes of both front and rear polarizers 50a and 50b in order to recycle dark state light as shown in FIG. 3H. As with the first embodiment of FIGS. 3A-3D, the embodiment of FIGS. 3G and 3H does not exhibit added contrast degradation due to ambient light.

### Third Embodiment

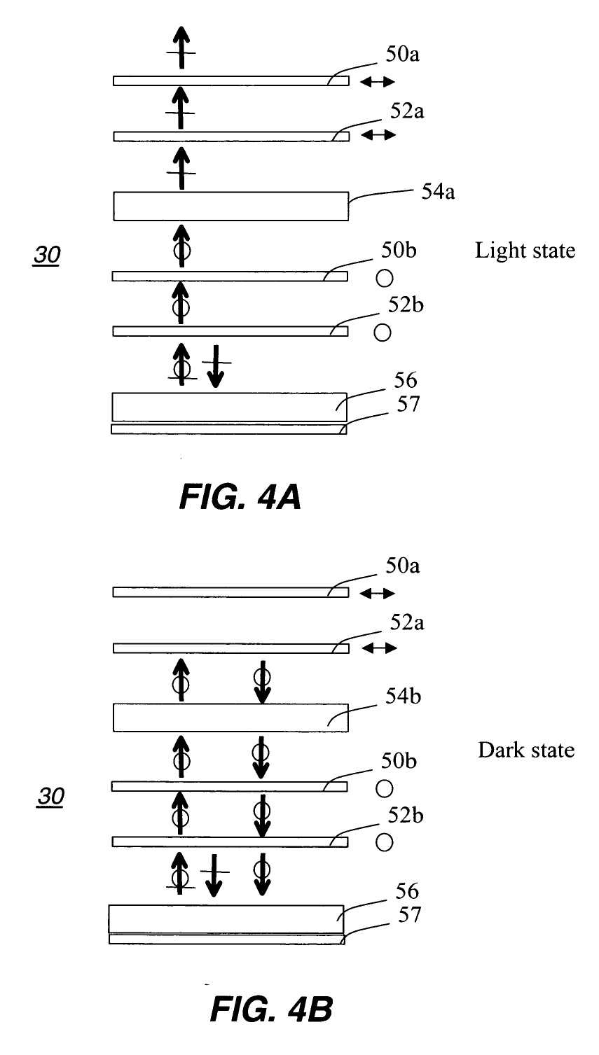

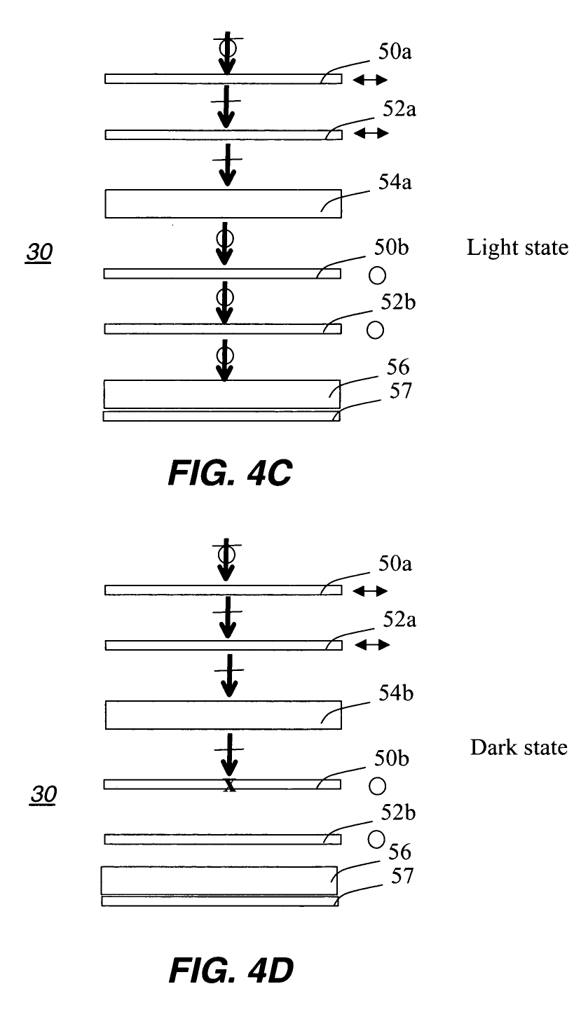

FIGS. 4A-4D show an LCD display 30 in an alternate embodiment. Here, a pair of reflective polarizers 52a and 52b is used to improve brightness and efficiency. The handling of light for light and dark states combines the features of the conventional use of a reflective polarizer shown in FIGS. 2A-2D with the inventive embodiment shown in FIGS. 3A-3D. Unpolarized light from backlight unit 56 is incident to rear reflective polarizer 52a that transmits one polarization (S-polarization in FIGS. 4A-4D) and reflects the orthogonal polarization back to backlight unit 56 for recycling. Rear polarizer 50b transmits light having S-polarization, absorbing any residual P-polarization component. Off state LC component 54a rotates the light polarization to provide output light having P-polarization. This light is then transmitted through both reflective polarizer 52a and front polarizer 50a.

FIG. 4B shows how LC display 30 handles light in the dark state. On state LC component 54b performs no rotation of light polarization. Recalling FIGS. 1B and 2B, light having S-polarization is conventionally absorbed by front polarizer 50a in the dark state. With the novel arrangement of FIGS. 4A-4B, however, reflective polarizer 52a reflects light having S-polarization back toward backlight unit 56. This behavior has a recycling effect, allowing this light to be reused for light state pixels.

FIGS. 4C and 4D shown how LC display 30 handles ambient light, in light and dark states, respectively. In the light state, some of the ambient light having S-polarization may be recycled and reused; ambient light having P-polarization is absorbed by rear polarizer 50b. Thus, the alternate embodiment of FIGS. 4A-4D provides increased brightness and efficiency, without compromising contrast due to ambient light effects.

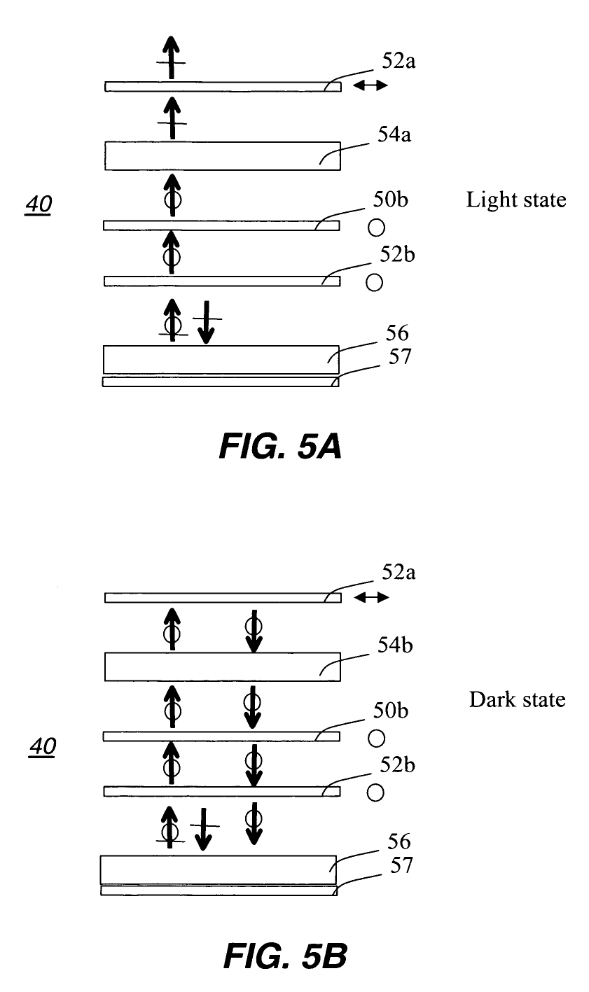

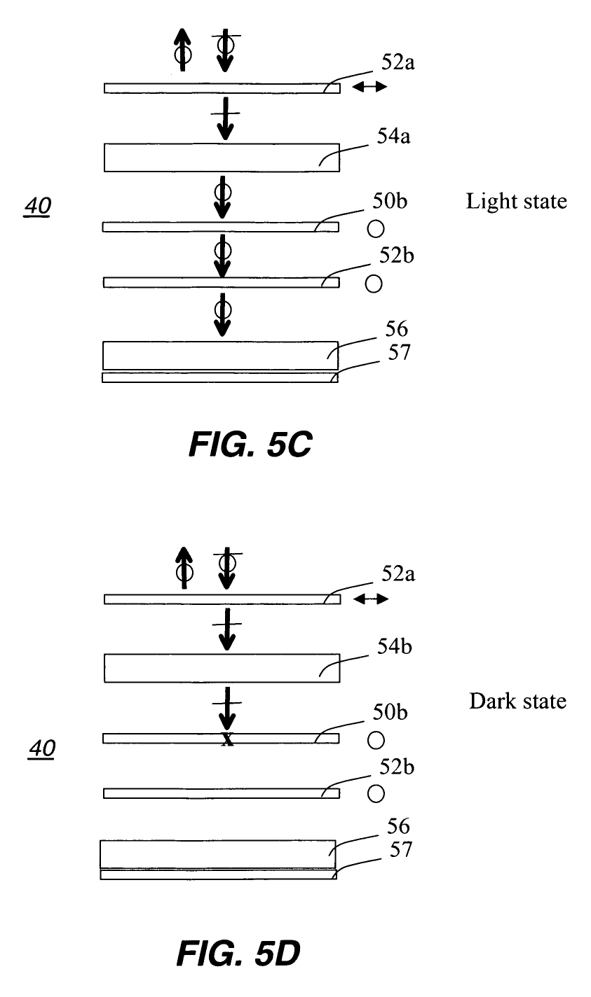

As noted in the background section given above, it has been pointed out that use of a reflective polarizer in place of front polarizer 50a is not advantageous for either brightness or contrast. FIGS. 5A-5D show LCD display 40 in an alternate embodiment with reflective polarizer 52a in this front position and show how ambient light may compromise contrast when this substitution is made. FIGS. 5A and 5B show this alternate arrangement, without front polarizer 50a, such that reflective polarizer 52a is in the front position relative to a viewer. The use of a second, rear reflective polarizer 52b is optional. Light state and dark state behavior is similar to that described with reference to the inventive embodiments of FIGS. 3A-3B and 4A-4B, with some advantageous recycling of dark state light, particularly where the optional rear reflective polarizer 52b is used.

FIGS. 5C and 5D show how LCD display 40 handles ambient light. In either light or dark state, reflective polarizer 52a reflects one polarization component. This reflection dramatically reduces display contrast, since stray light is introduced when a dark state is intended. Thus, while the use of reflective polarizer 52a without front polarizer 50a may offer some aesthetic appeal for providing a “metallic” appearance, this arrangement is not optimal due to contrast degradation.

For the embodiments disclosed herein, additional components may be added to enhance brightness and contrast. For example, a conventional collimating film such as Vikuiti™ Brightness Enhancement Film, manufactured by 3M, St. Paul, Minn. could be added to collimate the illumination. A collimating (or brightness enhancement) film for this purpose would be added to the configuration of FIGS. 3A-4D, typically disposed between backlight unit 56 and LC component 54a/54b. In one embodiment the collimating film is disposed between the rear polarizer and the backlight unit. Other known collimating films can be used as well.

Dark State Recycling

Referring to FIG. 7A, there is shown a plan view of a portion of an LCD display 20 with dark pixels 14 and light pixels 12. As FIG. 7A represents, each image formed on LCD display 20 has a percentage of dark pixels 14 and light pixels 12. The apparatus and method of the present invention takes advantage of light that is not needed for dark pixels 14 and redirects a portion of this light to light pixels 12. This behavior is summarized in FIG. 7B which shows how light can be redirected from dark pixel 14, formed by on state LC component 54b, to light pixel 12, formed by off state LC component 54a.

For describing how dark state recycling works in practice, the following variables are defined:
I₀ total flux of light from backlight unit 56
x percentage of dark pixels 14 to the total number of pixels
1−x percentage of light pixels 12 to the total number of pixels
T_{∥} transmittance of an absorptive polarizer (front polarizer 50a and rear polarizer 50b) for light polarized along the transmission axis
T_{lc} transmittance of the liquid crystal layer. As a first approximation, it can be assumed that T_{lc} is the same for both on-state and off-state
T_{f} transmittance of the front reflective polarizer 52a that is placed between front absorptive polarizer 50a and LC component 54a/54b
R_{f} reflectance of front reflective polarizer 52a that is placed between front absorptive polarizer 50a and LC component 54a/54b
Tᵣ transmittance of the rear reflective polarizer 52b that is placed between rear absorptive polarizer 50b and LC component 54a/54b
Rᵣ reflectance of the rear reflective polarizer 52b that is placed between rear absorptive polarizer 50b and LC component 54a/54b
R reflectance of backlight unit 56.

### EXAMPLE 1

### Dark State Light Recycling Without a Conventional Reflective Polarizer

Dark state recycling according to a first embodiment of the present invention can be illustrated by comparing light behavior in FIGS. 3A and 3B to light behavior in the conventional arrangement of FIGS. 1A and 1B.

Without dark state light recycling, as shown in FIG. 1A the total flux of light emitted from light pixels 12, with the percentage being 1−x, is as follows:
Iₜₒₜₐₗ₀≈0.5I₀T_{∥}²T_{lc}(1−x)

With dark state light recycling, that is, with reflective polarizer 52a placed between the front absorptive polarizer 50a and LC component 54a or 54b, the flux of light from light pixels 12, with the percentage being 1−x, is approximately 0.5I₀T_{∥}²T_{lc}T_{f}(1−x).

The flux reflected back from dark pixels 14, with the percentage being x, and from backlight unit 56 is approximately 0.5I₀T_{∥}²T_{lc}²R_{f}Rx.

This flux has a probability for being redirected though light pixels 12 of 1−x, and a probability for being redirected to dark pixels 14 of x.

After first recycling, the total flux coming out of light pixels 12 is

$${I}_{total 1} \approx 0.5 {I}_{0} {T}_{∥}^{2} {T}_{lc} {T}_{f} ( 1 - x ) + 0.5 {I}_{0} {T}_{∥}^{2} {T}_{lc}^{2} {R}_{f} Rx • 0.5 {T}_{∥}^{2} {T}_{lc} {T}_{f} ( 1 - x ) = 0.5 {I}_{0} {T}_{∥}^{2} {T}_{lc} {T}_{f} ( 1 - x ) [ 1 + 0.5 {T}_{∥}^{2} {T}_{lc}^{2} {R}_{f} Rx ]$$

After second recycling, the total flux coming out of light pixels 12

$${I}_{total 2} \approx {I}_{total 1} + {( 0.5 {I}_{0} {T}_{∥}^{2} {T}_{lc}^{2} {R}_{f} Rx )}^{2} •0 .5 {I}_{0} {T}_{∥}^{2} {T}_{lc} {T}_{f} ( 1 - x ) \text{is} = 0.5 {I}_{0} {T}_{∥}^{2} {T}_{lc} {T}_{f} ( 1 - x ) [ 1 + 0.5 {T}_{∥}^{2} {T}_{lc}^{2} {R}_{f} Rx + {( 0.5 {T}_{∥}^{2} {T}_{lc}^{2} {R}_{f} Rx )}^{2} ]$$

The total flux coming out of light pixels 12, then, is

$${I}_{DS} \approx 0.5 {I}_{0} {T}_{∥}^{2} {T}_{lc} {T}_{f} ( 1 - x ) [ 1 + 0.5 {T}_{∥}^{2} {T}_{lc}^{2} {R}_{f} Rx + {( 0.5 {T}_{∥}^{2} {T}_{lc}^{2} {R}_{f} Rx )}^{2} + … ] = 0.5 {I}_{0} {T}_{∥}^{2} {T}_{lc} ( 1 - x ) \frac{{T}_{f}}{1 - 0.5 {T}_{∥}^{2} {T}_{lc}^{2} {R}_{f} Rx}$$

The gain is defined as

$${\text{Gain}}_{DS} = \frac{{I}_{DS}}{{I}_{total 0}} - 1 = \frac{{T}_{f}}{1 - 0.5 {T}_{∥}^{2} {T}_{lc}^{2} {R}_{f} Rx} - 1$$

In an ideal case, T_{∥}, T_{lc}, T_{f}, R_{f}, and R are all equal to 1, thus

$$\text{Gain} = \frac{1}{1 - 0.5 x} - 1.$$

The maximum gain is 100% when x approaches 100%. The gain is 33% when x=50%. The gain is 0% when x=0%. The maximum gain of 100% is limited by rear polarizer 50b, which absorbs half of the light when the dark state light is recycled on each path.
Let f=T_{∥}²T_{lc}²R_{f}R, then

$${\text{Gain}}_{DS} = \frac{{T}_{f}}{1 - 0.5 fx} - 1$$

In practice, T_{∥}≅0.95, T_{lc}≅0.95, T_{f}≅0.9, R_{f}≅0.95, R≅0.9. f≅0.7.

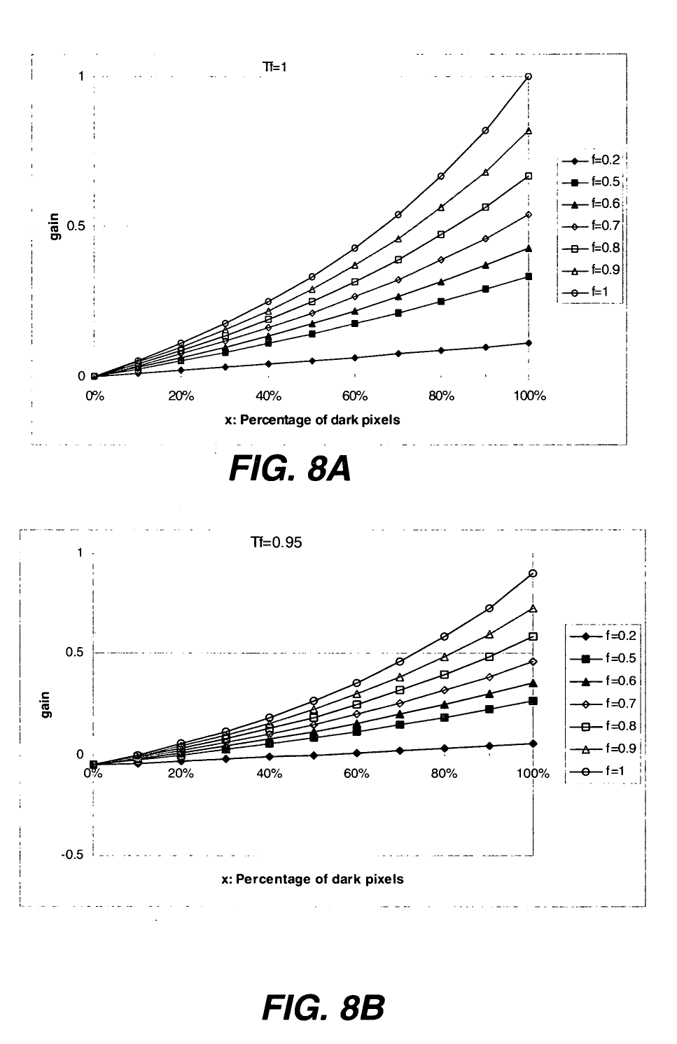

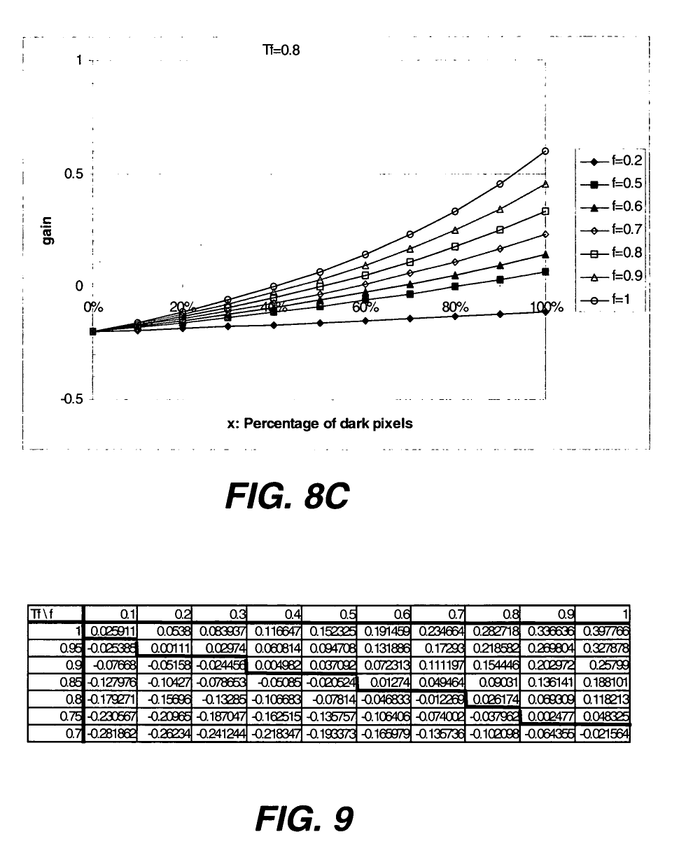

FIGS. 8A, 8B, and 8C show gain vs percentage of dark pixels 14 x for a transmittance T_{f} of reflective polarizer 52a at 100%, 95%, and 80%, respectively. In all cases, for given percentage of dark pixels 14, the higher the factor f, the higher the gain. At a fixed f, the higher the percentage of dark pixels 14, the higher the gain.

As shown in FIG. 8A, when the transmittance T_{f} of reflective polarizer 52a is 100%, the gain is always positive independent of the factor f and the percentage of dark pixels 14, x. When f=1 in an ideal case and x approaches 100%, the gain is 100%.

Referring to FIG. 8B, when the transmittance T_{f} of reflective polarizer 52a is less than 100%, here about 95%, the gain can be negative for small x, which indicates that there can be actual loss in light efficiency for an image with a small number of dark pixels 14 (or, conversely, with a large number of light pixels 12). But for an image with a large number of dark pixels 14 (or a small number of light pixels 12), i.e., a large x, the gain is positive.

Referring to FIG. 8C, when the transmittance T_{f} of reflective polarizer 52a is low enough, for example, 80%, the gain can be negative for all x between 0 and 1 for a small f (for example, f=0.2). But for a reasonably designed LCD system, in general, f>0.7. The curve corresponding to f=0.7 shows a positive gain when the percentage of dark pixels x>0.6.

Thus, it can be observed that dark state light recycling gain depends on the image shown on the display. To further quantify the gain, an average gain over x from 0 to 1 with equal weight is calculated at various f and T_{f} values. The average gain is shown in the table of FIG. 9. In order to have positive gain rather than loss, the factors f and T_{f} should obtain a value within the upper triangle of this table. For example, when T_{f}=0.75 and f>0.9, the average gain is positive. When T_{f}=0.9 and f>0.4, the average gain is also positive. When T_{f}=0.9 and f=0.7, the average gain is about 11%. The ranges of values f and T_{f} may vary when different criteria are adopted. The gain in light efficiency may also vary with the image pattern distribution rather than simply with the raw percentage of dark pixels 14. Overall, the transmittance of the reflective polarizer is preferably greater than 75% at the wavelength of interest.

### EXAMPLE 2

### Dark State Light Recycling in Combination with a Conventional Reflective Polarizer

Dark state recycling according to another embodiment of the present invention can be illustrated by comparing light behavior in FIGS. 4A and 4B to light behavior in the conventional arrangement of FIGS. 2A and 2B.

Referring to FIGS. 2A and 2B, without dark state light recycling and with conventional polarization recycling done by the reflective polarizer 52b, the total flux of light emitted from light pixels 12, with the percentage being 1−x, is

$${I}_{total}^{RP} \approx 0.5 {I}_{0} {T}_{∥}^{2} {T}_{lc} ( 1 - x ) \frac{{T}_{r}}{1 - 0.5 {R}_{r} R} \leq 2 {I}_{total 0}$$

Referring to FIGS. 4A and 4B, additional dark state light recycling takes place with reflective polarizer 52a placed between front absorptive polarizer 50a and LC component 54a or 54b, total flux coming out of light pixels 12, with the percentage being 1−x, is

$${I}_{DS}^{RP} \approx 0.5 {I}_{0} {T}_{∥}^{2} {T}_{lc} ( 1 - x ) \frac{{T}_{r}}{1 - 0.5 {R}_{r} R} \frac{{T}_{f}}{1 - {T}_{∥}^{2} {T}_{lc}^{2} {R}_{f} Rx} .$$

The gain compared to the case with polarization recycling by a conventional reflective polarizer is defined as

$${\text{Gain}}_{DS}^{RP} = \frac{{I}_{DS}^{RP}}{{I}_{total}^{RP}} - 1 \approx \frac{1}{1 - {T}_{∥}^{2} {T}_{lc}^{2} {R}_{f} Rx} - 1$$

In an ideal case, T_{∥}, T_{lc}, T_{f}, R_{f}, and R are all equal to 1, thus

$${\text{Gain}}_{DS}^{RP} = \frac{1}{1 - x} - 1.$$

Thus, ideally, the maximum gain has no upper limit when x approaches 100%. The gain is 100% when x=50%. The gain is 0% when x=0%.
Let f=T_{∥}²T_{lc}²R_{f}R, then

$${\text{Gain}}_{DS}^{RP} = \frac{{T}_{f}}{1 - fx} - 1$$

In practice, T_{∥}≅0.95, T_{lc}≅0.95, T_{f}≅0.9, R_{f}≅0.95, R≅0.9. f≅0.7. In this case, Gain_{DS}^{RP}=200% when x approaches 100%. Gain_{DS}^{RP}=38% when x=50%.
LCD System

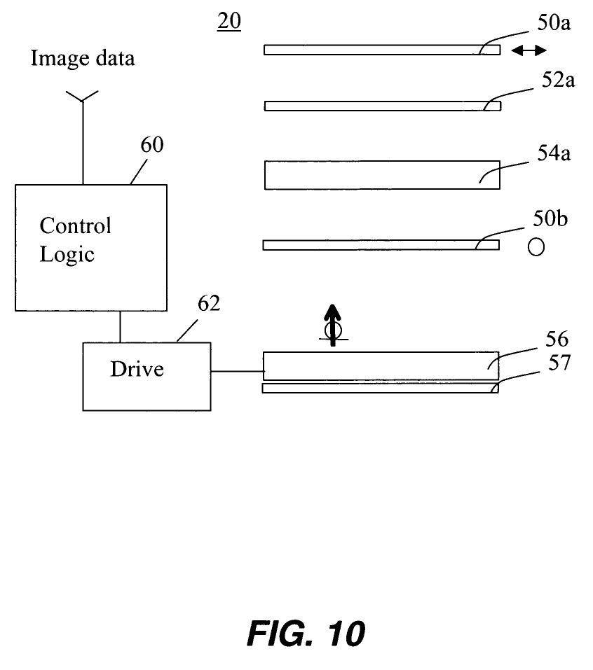

Recycling dark state light according to the present invention provides the light state pixels of the LCD with more light than the same pixels would receive for a conventional display without dark state light recycling. As is noted in the description given above, the incremental amount of added brightness depends, in part, on the percentage x of dark pixels. In some cases, it may be preferable to maintain a consistent level of pixel brightness for a given pixel data value, regardless of the percentage x of dark pixels. The present invention also provides an apparatus and method for maintaining this consistent brightness behavior by dynamically adjusting the source brightness of backlight unit 56 based on the percentage x of dark pixels. Referring to the block diagram of FIG. 10, there are shown the additional components provided for brightness control. A control logic processor 60 receives the image data and calculates the percentage x of dark pixels. Based on this calculation, control logic processor 60 modulates the signal to a drive circuit 62 that provides a variable signal to backlight unit 56. The light source provides an output that can be controlled. The light source for backlight unit 56 may be a light emitting diode (LED), an array of LEDs, or some other type of light source having sufficiently fast intensity response to a changing drive signal.

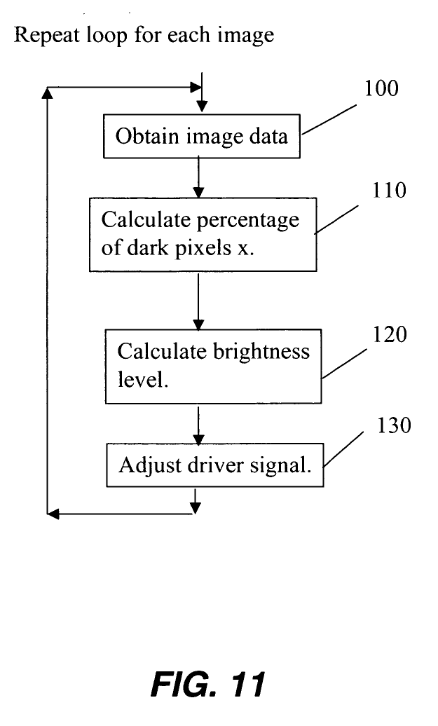

The control logic for brightness adjustment is straightforward, as is shown in the example block diagram of FIG. 11. For each image, image data is accessed in an obtain data step 100. A dark percentage calculation step 110 is then executed, in which percentage x of dark pixels is calculated from this data. Based on this calculation a brightness level calculation step 120 is executed, in which control logic computes a new brightness level, using an equation or using a look-up table, for example. Based on this calculated drive value, a drive signal adjustment step 130 is executed, directing this value to drive circuit 62, as an analog or digital signal. The control logic of FIG. 11 can be used for an individual image or used as a control loop, repeated for each of a succession of images.

Reflective Polarizer Types

The apparatus and method of the present invention can use a number of different types of reflective polarizer, more generally termed a reflective polarizing element, including a wire-grid polarizer (available from Moxtek, Inc., Orem, Utah), a circular polarizer such as a cholesteric liquid crystal component with a quarter-wave retarder, or a multilayer interference-based polarizer as well as with a collimating film such as Vikuiti™ Dual Brightness Enhancement Film, manufactured by 3M, St. Paul, Minn. In the wire-grid polarizer, thin wires are formed on a glass substrate. Wires can be faced toward the liquid crystal layer, functioning as electrode, alignment, and reflective polarizer. Wires can also be faced toward the front polarizer. Other known reflective polarizers can also be used. The reflective polarizer can be coupled to the surface of the liquid crystal spatial light modulator, meaning that the reflective polarizer and the liquid crystal light modulator share a common substrate. The reflective polarizer can be placed inside or outside of the substrate. Preferably, the reflective polarizer should produce little or no scattering effect.

For best performance, reflective polarizers should present as little retardance as possible, so as not to cause adverse effects to either light or dark state pixels. If there is retardance, the optical axis of the substrate is best oriented either parallel or perpendicular to the transmission axis of the reflective polarizer. It is also possible to incorporate compensation films as known in the art to improve viewing angle, contrast, and color purity of the reflective polarizers.

When a regular reflective polarizer is placed between the components of a liquid crystal display and its front polarizer 50a, two different types of light recycling can be obtained. First, dark state light recycling is observed, allowing bright pixels to provide about 10% more light in a dark background than in a bright background, as was described hereinabove. This first type of light recycling can be obtained with many, if not all, types of LC devices. A second type of light recycling is available with devices such as STN LCDs, wherein the LC device exhibits non-orthogonal polarization transmission axes or provides elliptically polarized light or provides a portion of unpolarized light. For this class of LC devices, additional bright state light recycling in a bright background can also be obtained, due to unique properties of these LCDs.

Devices Having Non-orthogonal Dark/Light States

As was noted hereinabove, there can be LC devices, such as STN devices, for which the polarization states of light that passes through LC components in dark and light states are not orthogonal. While the general ordered arrangement or stacking of components described with reference to FIGS. 3A and 3B and elsewhere also applies for these types of LC devices, there are additional considerations for optimizing light recycling with these devices.

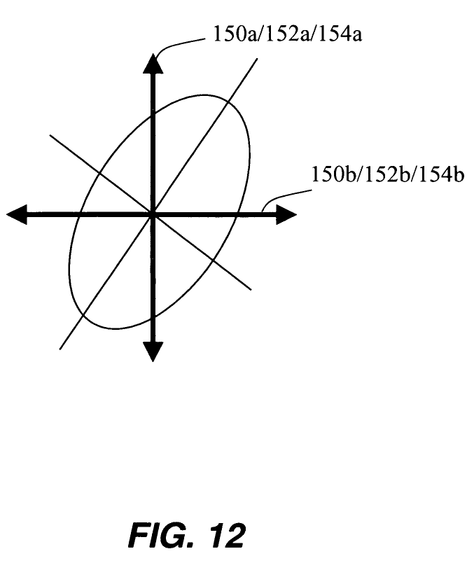

When there is a substantially orthogonal relationship of polarization states between bright state and dark state pixels, the major axes of devices and light can be represented as shown in FIG. 12. Here, the major axis orientation 152a of polarization state of light passing through a bright pixel is essentially the same as the transmission axis orientation 150a of front polarizer 50a and the transmission axis orientation 154a of reflective polarizer 52a. The major axis orientation 152b of polarization state for light passing through a dark pixel is essentially the same as the absorption axis orientation 150b of front polarizer 50a and the reflection axis orientation 154b of reflective polarizer 52a. Because of this arrangement, front polarizer 50a and rear polarizer 50b in a display device may be orientated to be substantially either parallel or perpendicular to each other as was shown in FIG. 2A and FIG. 2B.

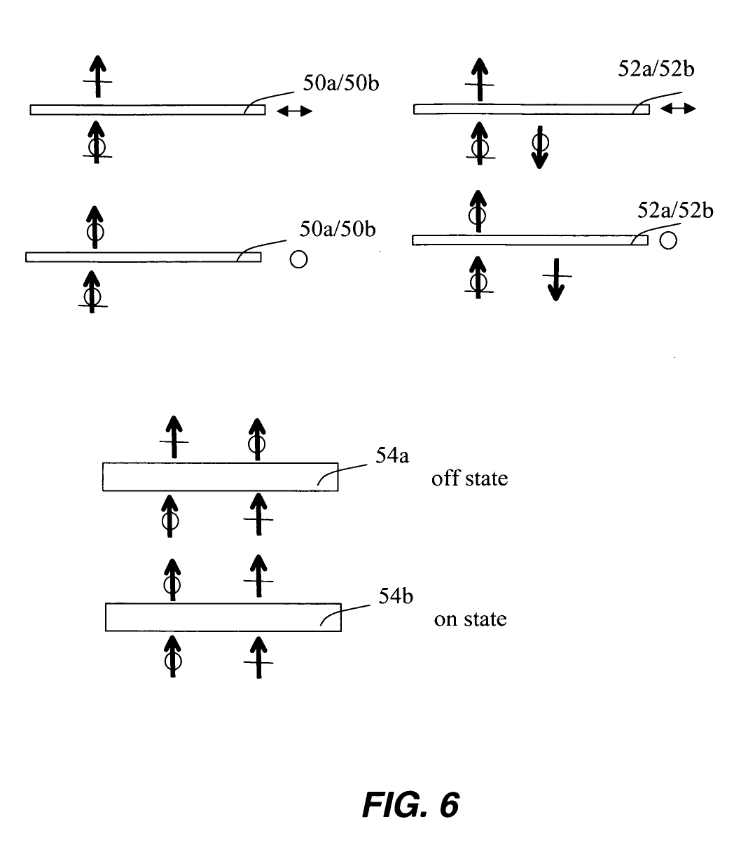

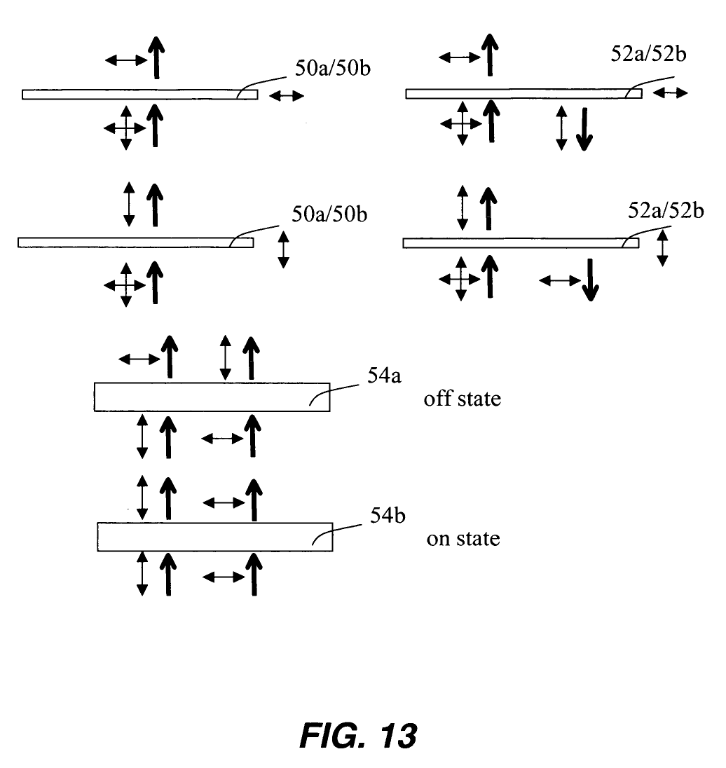

It has been observed, however, that not all LC devices exhibit the substantially orthogonal relationship of polarization states between bright state to dark state pixels. Because of this, an alternative polarization notation, as shown in FIG. 13, is more useful for describing the progress of light through these devices. In this alternative notation, unlike the more conventional notation introduced in FIG. 6, polarization state is represented in a plane normal to the propagation direction. Crossed arrows indicate the angular relationship for polarization between light state and dark state pixels. Referring to FIG. 13, this alternative notation for orthogonal states is shown for light incident on absorptive polarizer 50a, 50b and incident on reflective polarizer 52a, 52b.

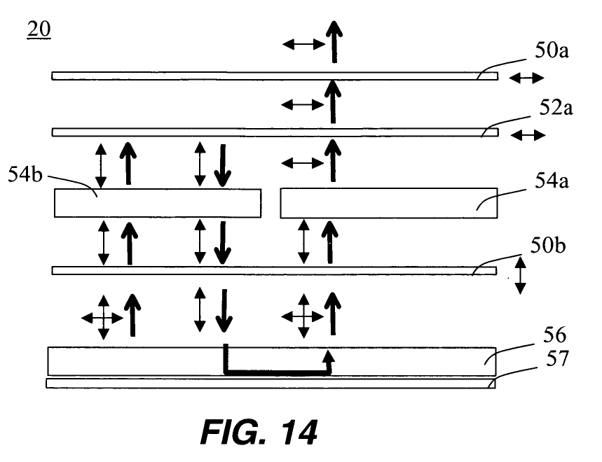

FIG. 14 shows dark state light recycling, available for conventional LC devices having orthogonal polarization states and using the notational convention of FIG. 13 instead of the notation used for the equivalent behavior in FIG. 7B. Light from backlight unit 56 and reflective film 57, initially unpolarized, is transmitted through a rear polarizer 50b, providing polarized light. On state LC component 54b does not rotate this polarization. Reflective polarizer 52a reflects incident light from on state LC component 54b back toward reflective film 57. From here, the reflected light can be added to light provided to off state LC component 54a, increasing its luminance thereby.

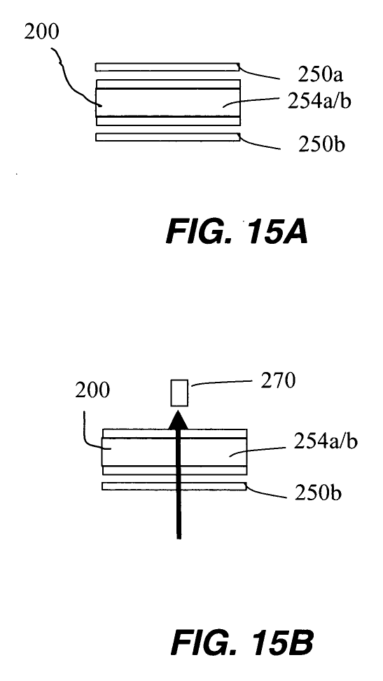

The Super Twisted Nematic (STN) LCD is one device that does not follow the conventional orthogonal arrangement of dark and light state polarization states. FIG. 15A shows a cross sectional view of a STN LC device 200 with a front polarizer 250a and a rear polarizer 250b and LC components 254a/254b.

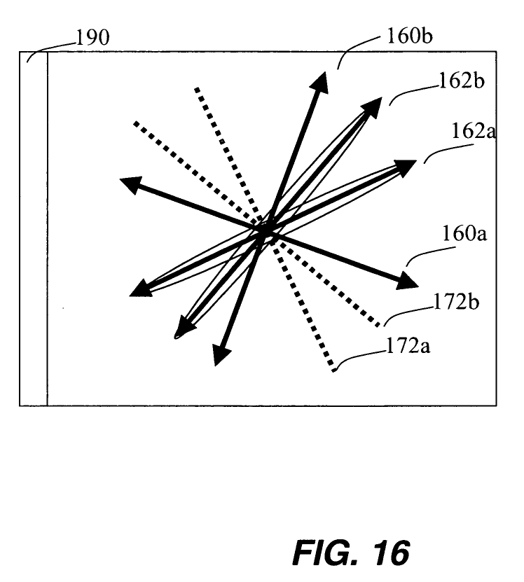

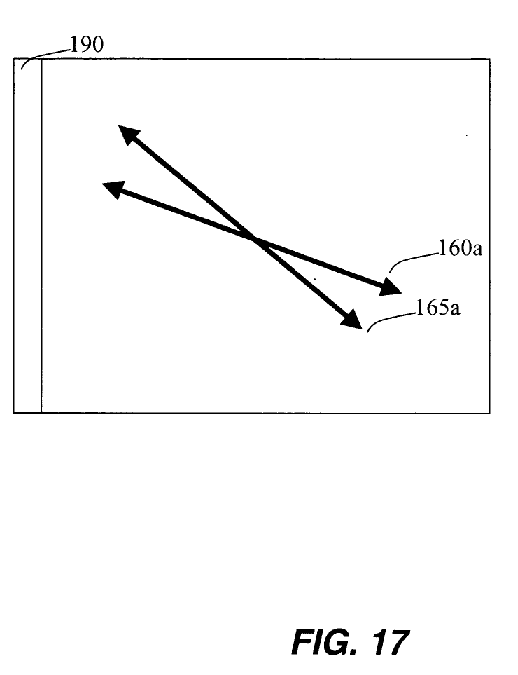

For a commercially available STN LCD from Epson (used as a 6″ monochrome VGA display), light and dark polarization states are disposed as shown in FIG. 16. When LCD components are in a light state, the polarization state measured in terms of an ellipse of polarization shows a major axis orientation 162a and a minor axis orientation 172a. When the LCD components are in a dark state, the polarization state shows a major axis orientation 162b and a minor axis orientation 172b. Referring to FIG. 17, the angle between a transmission axis orientation 160a of front polarizer 250a and a transmission axis orientation 165a of rear polarizer 250b is about 20 degrees, unlike the orthogonal or parallel relationship of earlier LC devices. In addition, when the LC components are in a light state, light passing through the LC components has an unpolarized component. For reference, a light source 190 is shown at the left side of the LCD panel in FIGS. 16 and 17.

FIG. 15B shows an experimental setup for characterizing the polarization state of light passing through rear polarizer 250b and LC components 254a/254b of STN LC device 200, with front polarizer 250a removed. A beam of helium neon laser light (632 nm) was directed through rear polarizer 250b and STN LCD components 254a/254b, and then into a polarization analyzer 270, such as an RPA2000 available from Instrument Systems GmbH, Germany. Though the polarization state varies somewhat with wavelength of light, observations made with light of 632 nm also apply to other visible light.

Measurement of the polarization state of STN LC device 200 reveals the following:

1) Light passing through light pixel LC component 254b is not linearly polarized. A few degrees of ellipticity can be observed.

2) The major axis orientation of the polarization state of light passing through light pixel LC component 254b is at about 46 degrees with respect to the transmission axis of the adjacent polarizer.

As shown in FIG. 16, the major axis orientations 162b, 162a of polarization states of light passing through dark and bright pixels are not perpendicular to each other with STN LC devices 200. Instead, the angle between the major axis orientations 162b, 162a is about 24 degrees. The transmission axis orientation 160a and absorption axis orientation 160b of front polarizer 50a are essentially perpendicular to each other. To balance brightness and contrast, transmission axis orientation 160a of front polarizer 50a makes an angle of approximately 44 degrees with the major axis orientation 162a of the polarization state of light passing through a bright pixel. Because the transmission axis orientation 164a and reflection axis orientation 164b of a conventional reflective polarizer are essentially perpendicular to each other, the transmission axis orientation and reflection axis orientation of a conventional reflective polarizer cannot be simultaneously matched to the polarization directions of light passing through a bright and dark pixels with STN types of LC devices. Thus, dark state light recycling using techniques disclosed above may be difficult to implement when using a STN LCD.

With STN LC devices 200 and other LC devices that exhibit non-orthogonal polarization states for light- and dark-state pixels, it may be necessary to compromise between arrangements for best brightness and best contrast. With reference to FIG. 16, best brightness is obtained when front polarizer 50a has its transmission axis oriented in parallel to major axis orientation 162a. Best contrast, however, is obtained when front polarizer 50a has its transmission axis oriented at a perpendicular to major axis orientation 162b.

Recently, monochrome LCDs have been adopted for the display of high-resolution gray level images such as for mammography or other medical images. One such example is the Dome C5i (available from Planar System, Inc., Beaverton, Oreg., USA), which includes a 21.3-inch monochrome 2-domain in-plane switching (IPS) LCD. Careful measurements on this type of monochrome LCD revealed that when front polarizer 50a is removed, light passing through a dark state pixel is substantially linearly polarized parallel to the absorption axis of front polarizer 50a, while light passing through a light state pixel or a gray level state pixel is not highly polarized. This is evident through luminance measurements over the LCD. In a dark state, the display luminance L1, for example, measured 1.99 Nits, when front polarizer 50a is arranged in a vertical direction (its original orientation). With front polarizer 50a rotated by 90 degrees or oriented horizontally, the measured luminance L2 was 994 Nits. In a light state, luminance L3 was 745 Nits with front polarizer 50a oriented in a vertical direction, and luminance L4 was 244 Nits with front polarizer 50a oriented in a horizontal direction. The ratio of L2 to L1 in a dark state is about 500, while the ratio of L3 to L4 in a light state is about 3. The low ratio of L3 to L4 in a light state was due to factors including light scattering caused by defects between sub domains in a pixel. The degree of polarization in a light pixel (with front polarizer 50a removed) measured by a polarization analyzer RPA2000 was only about 80% (the degree of polarization is 100% for completely polarized light). In summary, measured data over the STN and the IPS LCDs indicates that light passing through a light state pixel prior to front polarizer 50a may have substantial unpolarized component in addition to its polarized component. The polarized light may be either elliptically polarized or linearly polarized at an angle with respective to the transmission axis of the front polarizer. In either case, some portion of light in a bright state is parallel to the absorption axis of front polarizer 50a and is, therefore, absorbed by front polarizer 50a, reducing the brightness of the display.

Though this behavior whereby some portion of light through a light or gray state pixel is absorbed by front polarizer 50a is discussed referring specifically to monochrome STN and monochrome IPS devices, it is likely that this same behavior is exhibited by other types of LCDs including, but not limited to, twisted nematic (TN) LCDs, vertically aligned (VA) LCDs, particularly various kinds of multi-domain vertically aligned LCDs, multi-domain in-plane switching LCDs, optically compensated bend LCD (or pi-cells), and ferroelectric LCDs, either monochrome or full color LCDs.

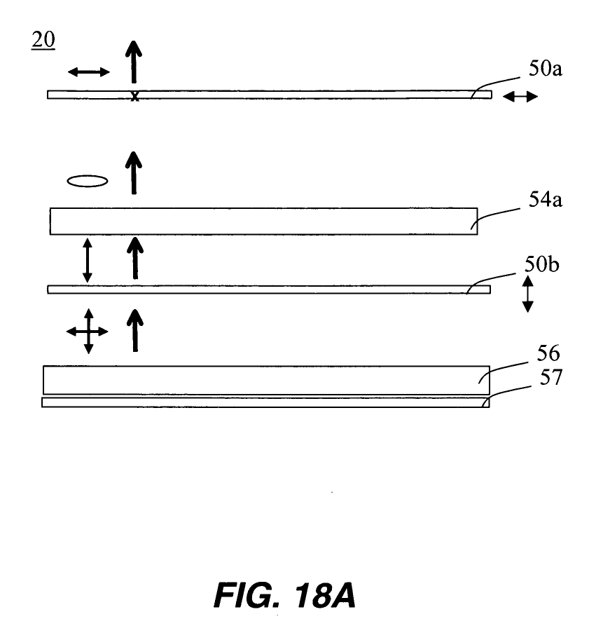

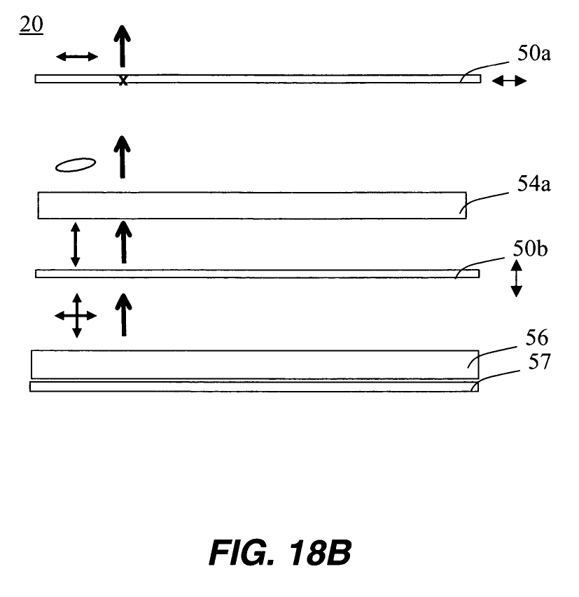

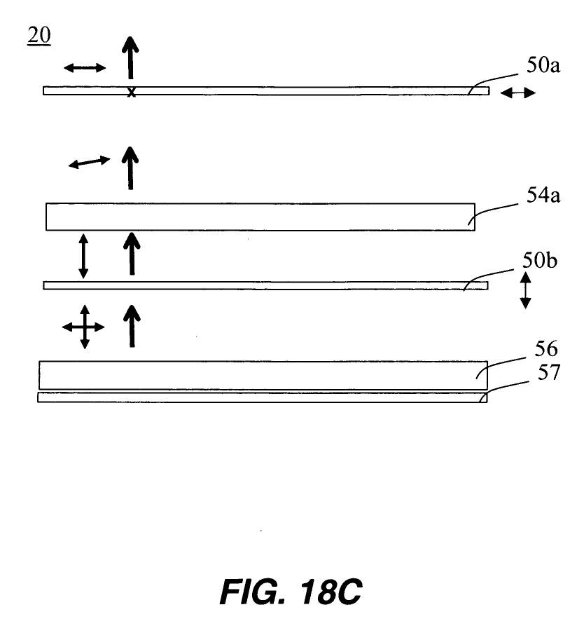

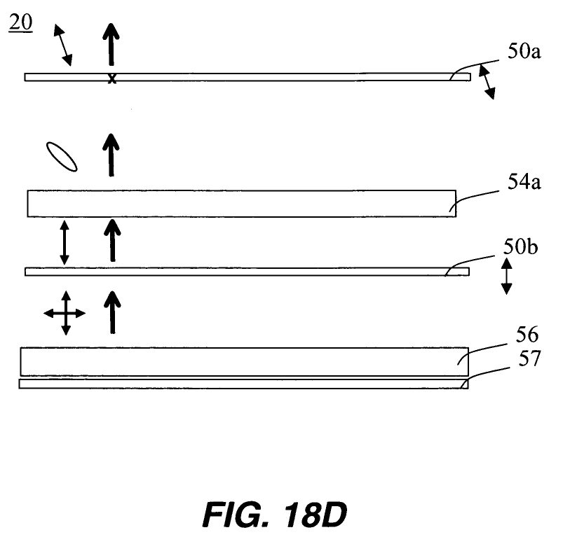

FIGS. 18A-18D summarize the behavior of light for a light or gray level state pixel. In FIG. 18A-18C, front and rear polarizers 50a, 50b have their transmission axes perpendicular to each other. In FIG. 18A, light passing through LC component 54a is elliptically polarized, with its major axis parallel to the transmission axis of front polarizer 50a. In FIG. 18B, light passing through LC component 54a is elliptically polarized, with its major axis oriented at an angle with respect to the transmission axis of front polarizer 50a. In FIG. 18C, light passing through LC component 54a is linearly polarized, with its major axis at an angle with respect to the transmission axis of front polarizer 50a. In each case for FIGS. 18A, 18B, and 18C, some portion of light is absorbed by front polarizer 50a, reducing brightness. The symbol “x” used in FIGS. 18A-18D indicates light extinction.

In FIG. 18D, front and rear polarizers 50a, 50b have their respective transmission axes oriented at an angle that is not an integer multiple of 90 degrees. Light passing through LC component 54a is elliptically polarized, with its major axis oriented at an angle with respect to the transmission axis of front polarizer 50a. In this case, some portion of light is absorbed by front polarizer 50a.

Other configurations exhibit the same problem in which light is absorbed unintentionally by front polarizer 50a. For example, in FIGS. 18A-18C, front and rear polarizers 50a, 50b can be oriented with transmission axes parallel to each other. In FIG. 18D, light passing through LC component 54a can be linearly or circularly polarized, with its major axis oriented at an angle with respect to the transmission axis of front polarizer 50a. In FIGS. 18A-18D, light passing through LC component 54a can also have an unpolarized component.

Embodiments with Parallel Transmission Axes of Polarizers

When front and rear polarizers 50a and 50b are oriented with transmission axes perpendicular to or parallel to each other, the reflective polarizer is preferably oriented with its transmission axis substantially parallel to the transmission axis of the front polarizer. In this configuration, dark state light recycling, as disclosed above, applies.

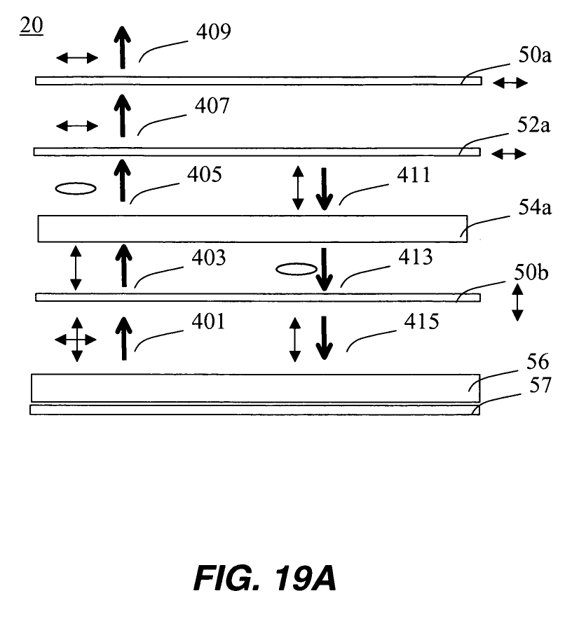

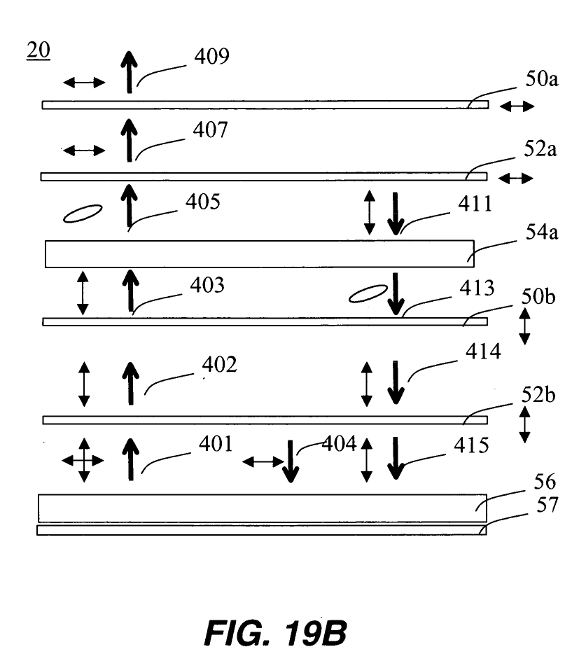

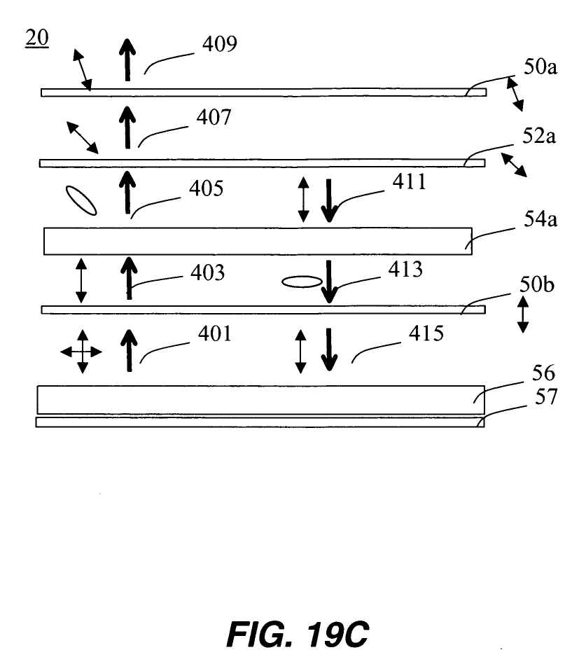

In addition to this dark state light recycling, there can be additional benefit obtained by bright state light recycling. FIG. 19A shows the principle of recycling bright state light that otherwise would be absorbed by front polarizer 50a, as was shown with reference to FIG. 18A. Essentially unpolarized light 401 is emitted from backlight unit 56 and is then polarized by rear polarizer 50b to provide polarized light 403. LC component 54a modulates this light to form elliptically polarized light 405, with its major axis substantially parallel to the transmission axis of front polarizer 50a. Most of this light passes through reflective polarizer 52a as light 407 and through front polarizer 50a, emerging as light 409. A minor portion of light that otherwise would be absorbed by front polarizer 50a is now reflected back toward backlight unit 56 by reflective polarizer 52a as light 411. Light 411 travels through LC component 54a, becoming elliptically polarized light 413. Some portion of light 413 is transmitted through rear polarizer 50b as light 415, which can then be redirected toward LC component 54a by backlight unit 56 and reflective film 57.

For the IPS LCD discussed above, as one example (where L3/L4=3), about 25% of light 405 is reflected as light 411 and about 75% of light 405 is transmitted as light 407 by reflective polarizer 52a. There will be about 25% of light 413 passing through rear polarizer 50b and becoming light 415.

In general, for an LCD having light α absorbed by front polarizer 50a, the ratio of light 415 to light 409 is approximately

$$\frac{{α}^{2}}{1 - α} .$$

Thus, for the example shown in FIG. 19A, relative to light 409, light 415 is approximately

$$\frac{0.25 \times 0.25}{0.75} = 8 \% .$$

Of course, when light losses associated with reflective polarizer 52a and LC component 54a are considered, the ratio will be smaller. Nevertheless, this recycling applies to all light state pixels and gray level state pixels, and improves light utilization efficiency for LC devices.

FIG. 19B shows another embodiment where an additional conventional reflective polarizer 52b is placed between rear polarizer 50b and backlight unit 56. In this embodiment, light 405 is elliptically polarized, with its major axis at an angle relative to the transmission axis of front polarizer 50a.

Embodiments with Transmission Axes of Polarizers at Acute Angle

For STN and other types of LC devices, it may be advantageous to orient the transmission axes of front and rear polarizers 50a and 50b at some acute angle, typically between 5 and 85 degrees. When the transmission axes of front and rear polarizers 50a and 50b are neither perpendicular nor parallel to each other, reflective polarizer 52a cannot be oriented at a direction that is optimized for both dark state and light state light at the same time. Thus, a tradeoff must be made between light throughput and contrast ratio. Reflective polarizer 52a can be oriented with its transmission axis substantially parallel to the transmission axis of front polarizer 50a. In this configuration, the transmission axis of reflective polarizer 52a can be oriented either in parallel with the transmission axis of front polarizer 50a, or at an angle with the transmission axis of front polarizer 50a, as shown in FIG. 19C.

These options for orientation of transmission axes can be applied to all LCD types for which the gray level light from of the LC device has properties similar to those described for the STN LCD. That is, reflective polarizer 52a can be oriented with transmission axis in parallel with, or at an acute angle to, the transmission axis of front polarizer 50a when any or all of the following apply:
1) light passing through a gray level state pixel LC component is not linearly polarized; and/or
2) the major axis orientation of the polarization state of light passing through a gray level state pixel makes a substantially nonzero angle with respect to the transmission axis of the adjacent front polarizer 50a; and/or
3) light passing through a gray level state pixel LC component is not completely polarized or its degree of polarization is less than 100%.

In FIGS. 19A-19C, only on-axis light 401 is described. It is noted that the description also applies to off-axis light, where light makes an angle relative to the normal of the LC device or of any of the optical components such as polarizers 50a, 50b. When off-axis light is reflected back toward LC component 54a, it may go through the neighboring pixels and cause visual defects. However, this problem can be minimized by placing reflective polarizer 52a proximate to LC component 54a. Where reflective polarizer 52a must be placed on the outside of a thin glass substrate, the glass thickness should be less than 0.5 mm, or more preferably less than 0.3 mm.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, light state and dark state behaviors of LC spatial light modulators can be reversed, as was shown with respect to FIGS. 3G and 3H. The use of reflective polarizer 52a between front and rear polarizers 50a and 50b necessitates some changes to the design of these other polarizing components, as can be well appreciated by those skilled in the optical arts. Reflective polarizer 52a can alternately be incorporated onto the surface of LC component 52a/52b, so that the spatial light modulator itself includes this reflective polarization component. The present invention could be used for a monochrome display or for a display using a color filter array, for example. A reflective color filter array, a polarizing reflective color filter array, or a polarizing backlight unit 56 could alternately be used.

The illumination provided from backlight unit 56 can be light that is substantially unpolarized or randomly polarized. In other embodiments, backlight unit 56 could provide light that is elliptically or linearly polarized. For example, an alternative illumination source for providing a linearly polarized light guide is described in the article entitled “Micro-structured Polymeric Linearly Polarized Light Emitting Lightguide for LCD Illumination” by H. J. B. Jagt, H. J. Comelissen, and D. J. Broer in SID 02 Digest pp. 1236-1239. The use of linearly polarized backlight unit 56 could obviate the need for a separate rear polarizer 50b and/or rear reflective polarizer 52b in many LC display applications.

Dark state, bright state, and gray level state light recycling described above can be incorporated into an “intelligent” or adaptive LC display. For example, in a radiology imaging display, at a given time, a viewer may only focus on a small portion of the entire display as the area of interest. In this situation, light from nearby dark state pixels can be recycled in order to boost brightness in the area of interest. To allow this, an area of interest is first identified; other areas of the image can then be reduced in brightness in order to redirect light to the area of interest, using the recycling methods of the present invention. Referring back to FIG. 10, adjustment of brightness and identification of an area of interest can be coordinated by control logic processor 60. An operator interface (not shown) such as a touchscreen, for example, could be used to provide control logic processor 60 with sufficient information to highlight one portion of a displayed image and reduce brightness over neighboring portions of the image.

Thus, what is disclosed is an LCD display using a reflective polarizer to recycle dark state light, providing improved efficiency and brightness.

### PARTS LIST

10 LCD display
12. Light pixel
14. Dark pixel
20, 30, 40 LCD display
50a Front absorptive polarizer
50b Rear absorptive polarizer
52a Reflective polarizer
52b Reflective polarizer
54a Off state 1c component
54b On state 1c component
54c Off state 1c component
54d On state 1c component
56 Backlight unit
57 Reflective film
60 Control logic processor
62 Drive circuit
100 Obtain data step
110 Dark percentage calculation step
120 Brightness level calculation step
130 Drive signal adjustment step
150a Transmission axis orientation
150b Absorption axis orientation
152a Major axis orientation (bright pixel)
152b Major axis orientation (dark pixel)
154a Transmission axis orientation
154b Reflection axis orientation
160a Transmission axis orientation
160b Absorption axis orientation
162a Major axis orientation of polarization state of light passing through a bright pixel of a STN
162b Major axis orientation of polarization state of light passing through a dark pixel of a STN
164a Transmission axis orientation
164b Reflection axis orientation
165a Transmission axis orientation
172a Minor axis orientation of polarization state of light passing through a bright pixel of a STN
172b Minor axis orientation of polarization state of light passing through a dark pixel of a STN
190 Light source
200 STN LC device
250a Front absorptive polarizer
250b Rear absorptive polarizer
254a Off state 1c component
254b On state 1c component
401 Unpolarized light
403 Polarized light
405 Elliptically polarized light
407 Light
409 Light
411, 413, 415 Light

1. A liquid crystal display comprising:
(a) a backlight unit for providing illumination;
(b) a rear polarizer disposed proximate the backlight unit for receiving the incident illumination and transmitting substantially polarized illumination;
(c) a liquid crystal spatial light modulator for forming a display beam by selective, pixel-wise modulation of the polarization of the substantially polarized illumination; and,
(d) a reflective polarizer disposed between the liquid crystal spatial light modulator and a front polarizer.

2. A liquid crystal display according to claim 1 wherein the reflective polarizer reflects a portion of dark state light back toward the backlight unit.

3. A liquid crystal display according to claim 1 wherein the reflective polarizer reflects a portion of gray state light back toward the backlight unit.

4. A liquid crystal display according to claim 1 wherein the reflective polarizer reflects a portion of white state light back toward the backlight unit.

5. A liquid crystal display according to claim 1 wherein the reflective polarizer is coupled to the surface of the liquid crystal spatial light modulator.

6. A liquid crystal display according to claim 1 wherein the transmittance of the reflective polarizer is greater than 75%.

7. A liquid crystal display according to claim 1 further comprising an additional reflective polarizer disposed between the rear polarizer and the backlight unit.

8. A liquid crystal display according to claim 1 further comprising a collimating film disposed between the rear polarizer and the backlight unit.

9. A liquid crystal display according to claim 1 further comprising a compensation film.

10. A liquid crystal display according to claim 1 wherein the respective transmission axes of the front and rear polarizers are parallel to each other within ±10 degrees.

11. A liquid crystal display according to claim 1 wherein the respective transmission axes of the front and rear polarizers are orthogonal to each other within ±10 degrees.

12. A liquid crystal display according to claim 1 wherein the respective transmission axes of the front and reflective polarizers are parallel to each other within ±10 degrees.

13. A liquid crystal display according to claim 1 wherein the reflective polarizer is a wire grid polarizer.

14. A liquid crystal display according to claim 1 wherein the reflective polarizer comprises a multilayer interference-based polarizer.

15. A liquid crystal display according to claim 1 wherein the reflective polarizer comprises a circular polarizer with a quarter wave retarder.

16. A liquid crystal display according to claim 1 wherein the backlight unit comprises at least one light source with an output that can be controlled.

17. A liquid crystal display according to claim 16 wherein the light source comprises one or more light emitting diode.

18. A liquid crystal display according to claim 1 wherein the liquid crystal spatial light modulator is taken from the group consisting of an super twisted nematic, an in-plane switching, a twisted nematic, a vertically aligned, and an optically compensated bend liquid crystal spatial light modulator.

19. A liquid crystal display according to claim 1 wherein the transmission axis of the front polarizer is oriented at an angle of between 5 and 85 degrees with respect to the transmission axis of the rear polarizer.

20. A liquid crystal display according to claim 1 wherein the transmission axis of the reflective polarizer is oriented at an angle of between 5 and 85 degrees with respect to the transmission axis of the rear polarizer.

21. A liquid crystal display according to claim 1 wherein the backlight unit provides substantially unpolarized illumination.

22. A liquid crystal display according to claim 1 wherein the backlight unit provides polarized illumination.

23. A liquid crystal display comprising:
(a) a backlight unit providing illumination;
(b) a first reflective polarizer, having a transmission axis, for
(i) transmitting that portion of light from the incident backlight unit illumination that has polarization parallel to the transmission axis; and,
(ii) reflecting light having a polarization orthogonal to the transmission axis;
(c) a rear polarizer for receiving the polarized illumination transmitted from the first reflective polarizer;
(d) a liquid crystal spatial light modulator for forming an image by selective, pixel-wise modulation of polarization of the polarized illumination; and,
(e) a second reflective polarizer disposed between the liquid crystal spatial light modulator and a front polarizer for reflecting a portion of light from the liquid crystal spatial light modulator back toward the backlight unit.

24. A liquid crystal display according to claim 23 wherein the second reflective polarizer is coupled to the surface of the LC spatial light modulator.

25. A liquid crystal display according to claim 23 wherein the transmittance of the second reflective polarizer is greater than 75%.

26. A liquid crystal display according to claim 23 further comprising a collimating film disposed between the rear polarizer and the backlight unit.

27. A liquid crystal display according to claim 23 further comprising a compensation film.

28. A liquid crystal display according to claim 23 wherein the respective transmission axes of the front and rear polarizers are parallel to each other within ±10 degrees.

29. A liquid crystal display according to claim 23 wherein the respective transmission axes of the front and rear polarizers are orthogonal to each other within ±10 degrees.

30. A liquid crystal display according to claim 23 wherein the respective transmission axes of the front polarizer and second reflective polarizer are parallel to each other within ±10 degrees.

31. A liquid crystal display according to claim 23 wherein the first reflective polarizer is a wire grid polarizer.

32. A liquid crystal display according to claim 23 wherein the second reflective polarizer is a wire grid polarizer.

33. A liquid crystal display according to claim 23 wherein the second reflective polarizer comprises a multilayer interference-based polarizer.

34. A liquid crystal display according to claim 23 wherein the second reflective polarizer comprises a circular polarizer with a quarter wave retarder.

35. A liquid crystal display according to claim 23 wherein the backlight unit comprises at least one light source with an output that can be controlled.

36. A liquid crystal display according to claim 23 wherein the light source comprises one or more light emitting diode.

37. A liquid crystal display according to claim 23 wherein the second reflective polarizer reflects a portion of dark state light back toward the backlight unit.

38. A liquid crystal display according to claim 23 wherein the second reflective polarizer reflects a portion of gray state light back toward the backlight unit.

39. A liquid crystal display according to claim 23 wherein the second reflective polarizer reflects a portion of white state light back toward the backlight unit.

40. A liquid crystal display according to claim 23 wherein the transmission axis of the front polarizer is oriented at an angle of between 5 degrees and 85 degrees with respect to the transmission axis of the rear polarizer.

41. A liquid crystal display according to claim 23 wherein the liquid crystal spatial light modulator is taken from the group consisting of an super twisted nematic, an in-plane switching, a twisted nematic, a vertically aligned, and an optically compensated bend liquid crystal spatial light modulator.

42. A liquid crystal display according to claim 23 wherein the transmission axis of the front polarizer is oriented at an angle of between 5 and 85 degrees with respect to the transmission axis of the rear polarizer.

43. A liquid crystal display according to claim 23 wherein the transmission axis of the first reflective polarizer is oriented at an angle of between 5 and 85 degrees with respect to the transmission axis of the rear polarizer.

44. A liquid crystal display according to claim 23 wherein the backlight unit provides substantially unpolarized illumination.

45. A liquid crystal display according to claim 23 wherein the backlight unit provides polarized illumination.

46. A method for adjusting display brightness comprising:
a) providing backlight illumination to a transmissive liquid crystal display component;
b) forming an image beam by pixel-wise modulation of the polarization of the backlight illumination according to image data;
c) disposing a reflective polarizer in the path of the image beam;
d) determining, based on the image data, the relative proportion of dark pixels to light pixels; and,
e) modulating the backlight illumination brightness level based on the relative proportion of dark to light pixels for the displayed image.

47. A method according to claim 46 wherein the step of modulating the backlight illumination brightness level comprises the step of varying the drive current to a light source that can be controlled.

48. A method according to claim 46 wherein the light source comprises one or more LEDs.

49. A liquid crystal display comprising:
(a) a backlight unit for providing illumination;
(b) a rear polarizer having a transmission axis, the rear polarizer disposed proximate the backlight unit for receiving the incident illumination and transmitting substantially polarized illumination in alignment with its transmission axis;
(c) a liquid crystal spatial light modulator for forming a modulated beam by selective, pixel-wise modulation of the polarization of the substantially polarized illumination;
(d) a front polarizer having a transmission axis for transmitting the portion of the modulated beam having polarization in alignment with its transmission axis; and,
(e) a reflective polarizing element disposed between the liquid crystal spatial light modulator and the front polarizer, the reflective polarizing element reflecting a portion of light back toward the backlight unit;
wherein the transmission axis of the front polarizer is oriented at an angle of between 5 degrees and 85 degrees with respect to the transmission axis of the rear polarizer.

50. A liquid crystal display according to claim 49 wherein the liquid crystal spatial light modulator is of a super twisted nematic type.

51. A liquid crystal display according to claim 49 wherein the reflective polarizing element is a wire grid polarizer.

52. A liquid crystal display according to claim 49 wherein the transmission axis of the reflective polarizer is oriented at an angle of greater than 5 degrees with respect to the transmission axis of the front polarizer.

53. A liquid crystal display according to claim 49 wherein the backlight unit provides substantially unpolarized illumination.

54. A liquid crystal display according to claim 49 wherein the backlight unit provides polarized illumination.

55. A liquid crystal display according to claim 49 further comprising a control logic processor for adjusting brightness according to an area of interest identified in the displayed image.
